(19) United States
(12) Patent Application Publication
(10) Pub. No.: US 2024/0081963 A1
(43) Pub. Date: Mar. 14, 2024

(54) FLOSSING DEVICE

(71) Applicant: FLAUS LLC, Manhattan Beach, CA (US)

(72) Inventors: Samantha Claire COXE, Manhattan Beach, CA (US); Taylor Reid JOLIN, Manhattan Beach, CA (US); Andrew Ryan NAMMINGA, Newport Beach, CA (US)

(21) Appl. No.: 18/304,039

(22) Filed: Apr. 20, 2023

Related U.S. Application Data
(60) Provisional application No. 63/333,291, filed on Apr. 21, 2022.
(60) Provisional application No. 63/333,298, filed on Apr. 21, 2022.

(51) Int. Cl. A61C 15/04

(52) U.S. Cl. CPC A61C 15/047; A61C 15/048

(57) ABSTRACT

The flossing device includes a head unit, a handle, and a neck that is coupled to the head unit at one end and to the handle at an opposite end. The flossing device provides a horizontal vibrational movement for flossing. The handle of the flossing device includes a drive motor and a drive mechanism that transfers drive motor rotation into a horizontal left-right displacement of the head unit to generate the horizontal vibrational movement of the floss. The horizontal vibration provides more efficient and effective flossing. The drive mechanism includes a cam and an eccentric collar that generates horizontal left-right displacement as the cam rotates. The drive mechanism also includes an elongated shaft with a head adapter to secure the neck to the head unit; a sidewall spacer surrounding a portion of the elongated shaft to limit the horizontal left-right displacement; and an eccentric collar that mates with the drive motor to generate the horizontal vibrational movement of the head unit.

### TECHNICAL FIELD

The invention relates to a portable dental device for cleaning teeth and more specifically to a flossing device for use in cleaning interdental areas between teeth. More specifically, the dental device has rotating, vibrating, or floss-feeding capabilities used to clean interdental areas between teeth.

### BACKGROUND

Flossing is recommended to remove plaque and food particles in places where a toothbrush cannot easily reach, such as under the gumline and between teeth. Because plaque and residual food particles can lead to tooth decay and gum disease, daily flossing is considered an essential part of maintaining tooth and gum health.

Manual flossing is effective to help remove debris and plaque from the teeth. Manual flossing can include the use of strands of floss, a floss pick, and other interdental cleaners. However, manual flossing takes time and careful attention to clean interdental areas. Alternatives to manual flossing include water flossers, dental picks, pre-threaded flossers, autoflossers, and other flossing devices. Some of these flossing devices include different drive mechanisms such as counter-weight motors or sonic vibrational motors to generate oscillations for the device. Many of these currently known drive mechanisms are unsatisfactory, however, as they fail to provide adequate power for the device, they may bind or stall when the shaft of the devices is flexed, or they need a much larger motor to create the oscillations required for the flossing device to work effectively. Additionally, conventional counter-weight motors fail to transfer enough power to the flossing head unit because of their distance to the head unit. Other conventional flossers vibrate about axes that provide an uncomfortable experience to the user. Additionally, sonic flossers often generate an uncomfortable sensation to the user when vibrating and often vibrate too powerfully, which may result in irritation or injury to a user. In part because of these and other deficiencies in currently known and available flossing devices, there remains a need for flossing devices which improve upon these flawed versions, are hygienic easy to use, and promote regular and effective cleaning.

### SUMMARY

The vibrating flossing device in accordance with the invention addresses the problems and needs described above and promotes good dentition. The vibrating flossing device cleans teeth and gums using a greater range-of-motion and eliminates binding of the drive mechanisms when floss is stuck between teeth that can often be difficult to reach with regular brushing. The vibrating flossers provide a technical solution to the problems with prior systems. In some embodiments of the invention, the flossers use a driving mechanism that vibrates along a left-to-right axis with minimal movement up-to-down and front-to-back. This range and pattern of motion provides an optimal force that is effective in removing plaque and food particles but does not irritate or injure a user flossing their teeth. In this specification, the terms “flossing device”, “flosser”, and similar variations used are intended to be equivalent.

The invention addresses the needs described above by providing a flossing device that vibrates while flossing, feeds new floss when needed, and includes an easily replaceable head that holds the floss. In this specification, the terms “flossing device”, “flosser”, and variations thereof and used herein are intended to be viewed as equivalent.

The flossing devices in accordance with the invention address problems and needs described above and promote good dentition. The flossing devices include a handle, neck, and a head unit. The handle powers the device, and the head unit interfaces with the handle and holds and advances the floss. This flossing device includes a reverse locking mechanism that keeps the floss taut in the device and vibrates the floss to assist in the cleaning process.

The flossing devices in accordance with the invention include a handle, a neck, and a head unit, which contains floss. In some example embodiments, the head unit, neck, and handle can be integrated into a single unit that is replaceable or permanently joined together, while allowing replacement of the floss. In other example embodiments, the head unit and neck can be an integrated unit with a separate handle and replacement floss. In additional embodiments, the head unit, neck, and handle are modular and can be separately replaceable, along with the floss. In some embodiments, the head unit and/or the neck can be interchangeable and fitted to a single handle, such as when more than one user uses the flosser. Each person can have their own head unit and/or neck while sharing the same handle. The head unit and/or neck can be different sizes to be used in different sized mouths.

In one embodiment of the invention, the handle of the flossing device includes a drive motor and a power unit. The drive motor vibrates the head unit, which in turn vibrates the floss. The vibrating floss provides movement that helps remove plaque and food particles between teeth and the underlying bacteria. Flossing with the vibrating flossing device of the invention is more effective than using conventional flossers because of the vibrating motion.

In use, the drive motor drives the head unit, and subsequently moves the floss, so that the floss penetrates tight spaces between the teeth more easily and removes plaque more effectively. The drive motor rotates, and in combination with cams and gears generates a left-to-right vibration with minimal up-and-down and front-to-back movement. This planar movement generated by the vibrating flossers is ideal for interdental flossing.

In some embodiments of the invention, the drive motor can be an eccentric rotating mass (ERM) vibration motor, sonic vibration motor, or linear resonance actuator (LRA) motor, each of which provides vibratory effects to the exposed length of floss. Some ERM vibration motors can include a brushless cylinder motor. In other example embodiments of the invention, the motor can be a counter-weight motor, a brushed motor, a stepper motor, a brushless motor, and other types of AC and DC motors.

The flossing devices in accordance with the invention can include a handle that includes a microcontroller that operates the drive motors. However, in some embodiments, the drive motor does not require a microcontroller to operate. The flossing devices utilize waterproofing and/or water-resistance features so water or liquid used to rinse or clean the device does not seep into the interior floss storage compartment(s) or the power circuitry in the handle.

The power unit can use a convenient source of electrical power, such as a battery, to provide electromotive force to the flossing device. The battery can be rechargeable or disposable, depending upon the particular implementation of the invention. Alternatively, the power unit can include a connection to a domestic power source, such as a convenience outlet to which the device is connected via a power cord or cable during use. In certain embodiments, a rechargeable battery can be charging while the device is in use and connected to an electrical convenience outlet. In certain embodiments, a light on the body of head unit of the device indicates a low battery.

In an example embodiment of the invention, the handle includes a charging interface for charging the power unit. For example, the charging interface can be a micro-USB port, an electrical socket, or other plug or socket for connection to a power supply, such as a domestic electrical convenience outlet. The charging interface can accept a direct electrical connection to a power source such as a USB drive or an electrical outlet. Alternatively, the flossing devices can include an internal electrical converter to convert an electrical supply to a voltage that is usable by the flossing device. A power cable can include an in-line converter that converts an input voltage to an output voltage usable by the device. The flossing device can be configured as a dual voltage device to connect to both 110-120V and 220-240V domestic power sources, or to other power sources as may be desirable.

In an example embodiment of the invention, the flossing device can include one or more switches implementing a variety of functions. For example, the flossing device can include a vibration switch to cause the floss to vibrate. Depending upon the particular implementation of the invention, the vibration switch can be a single switch that has, for example, multiple detents or settings to enable multifunctional uses. These multiple functions can be implemented using a single button feature on the housing. The button can be configured to have the drive motor vibrate the floss at a single setting (e.g., vibrating speed or strength), or at a plurality of vibrational settings (e.g., with different vibrating speeds or strengths), or at other settings along a continuum.

The flossing device is water-resistant and/or waterproof to prevent moisture from entering the device or damaging any electrical or other internal components. Components of the flossing device can be configured with user-replaceable components such as a battery, replacement floss, including the head unit, neck, and handle components.

The floss used in the head unit of the flossing device can be conventional waxed or unwaxed floss, dental tape, PTFE floss, or other kinds of floss configured to work with the components of the flossing device. In addition, the floss can be flavored, colored, and have a particular texture or smoothness to provide a particular sensory or cleaning experience to the user.

In an example embodiment of the invention, the housing of the head unit includes a pair of arms with distal ends to hold the floss. The pair of arms may be moveable from a closed configuration wherein the distal ends of the arms enclose the path of floss to prevent contamination of previously unused floss, to an operational configuration where the distal ends of the arms separate to open the exposed length of floss for use. The arms can also have a fixed configuration to hold the floss in place. The housing of the head unit can further include a cover that is removed by detaching, sliding, or otherwise moving the cover to expose floss for use. After flossing is complete, the cover can be reaffixed to the head unit so that the unused floss remains clean and sanitary for subsequent use.

The head unit can be detachable from the handle/neck and replaceable with another head unit. The different head units can belong to different users, can be different sizes, can be pre-loaded with new floss, and can be interchanged by the different users. These example embodiments allow users to replace the used floss in the device with a fresh supply of floss. The head unit and handle can each have complementary locking features that cooperate to lock and unlock the head unit to the handle. Such locking features can be implemented using snap-fit mechanisms, buttons, tabs, or other locking elements.

The flossing device can include an indicator cue that indicates one or more conditions affecting use. For example, the flossing device can provide an indication of a need for fresh floss, an adjustment of the head unit, a low power level, and an incomplete connection between the head unit and the handle. An indicator cue can be implemented, for example, using a blinking warning light, LEDs, tone, vibration, and other visual, audio, or sensory cues. In one example embodiment, the indicator cue can utilize a plurality of LEDs, and each LED can indicate a different condition. Some other conditions that can be tracked and displayed include measures that track user flossing habits and progress, as well as indications that the device is updating or connecting to another device to upload history of use. A Wi-Fi connection or other communication interface can be included to facilitate flossing data measurement transfers and tracking.

To maintain the floss inside the flossing device in a hygienic manner, the flossing device can include a sanitizer reservoir containing sanitizer that is applied to used floss to help eliminate bacteria on the floss as well as to prevent bacterial growth. The sanitizer can be a liquid or a gel, for example, and can include one or more disinfectant, antiseptic, bactericidal, and/or bacteriostatic agents. In one example, alcohol and/or quaternary ammonium compounds are used. The sanitizer reservoir can be in the head unit and can be applied to the used floss at any appropriate position in the device. In other embodiments, the sanitizer reservoir can extend from the handle or neck to the head unit to apply sanitizer to the floss. The sanitizer can be applied to the used floss by running the floss against a sponge moistened with the sanitizer, moving the floss through a reservoir of sanitizer, and other configurations where the sanitizer contacts the floss. In other embodiments, the sanitizer can be in the form of an ultraviolet lamp that shines ultraviolet light on the floss and on the device to eliminate bacteria. The ultraviolet lamp can be a UV-C diode that disinfects the floss by killing bacteria, for example.

The flossing devices include a head unit, a handle, and a neck coupled to the head unit at one end and to the handle at an opposite end. The flosser provides a horizontal vibrational movement for flossing. The handle of the flosser includes a drive motor and mechanism that transfers drive motor rotation into a horizontal left-right displacement of the head unit to generate the horizontal vibrational movement of the floss. The horizontal vibration provides more efficient and effective flossing. The drive mechanism includes a cam and an eccentric collar that generates horizontal left-right displacement as the cam rotates. The drive mechanism also includes an elongated shaft with a head adapter to secure the neck; a sidewall spacer surrounding a portion of the elongated shaft to limit the horizontal left-right displacement; and an eccentric collar that mates with the drive motor to generate the horizontal vibrational movement of the head unit.

The flossing devices can include a power unit. The handle can include an interface to a power cable for charging the power unit. The head unit can include floss. The neck or the head unit can include a bite pad as a location for a user to bite down to manipulate floss during flossing. The flossing device can include a wireless transceiver to communicate with another device.

The drive mechanism of the flossers can include a pinion gear fitted in a cavity in the handle and powered by the drive motor. The drive mechanism can include a cam and an eccentric collar that generates horizontal left-right displacement as the cam rotates. The drive mechanism can include an elongated shaft with a head adapter to secure the neck, a sidewall spacer surrounding a portion of the elongated shaft to limit the portion of the elongated shaft to the horizontal left-right displacement, and an eccentric collar that mates with the drive motor to generate the horizontal vibrational movement of the head unit. The sidewall spacer extends radially from a longitudinal axis of the elongated shaft. The eccentric collar includes a substantially box-like shape.

The flossing devices can include a drive mechanism that includes a pinion gear connected to a large gear, wherein the pinion gear is tapered and beveled to mate to the large gear and to transfer rotational force of the drive motor to the large gear and through to a cam and eccentric collar and wherein the cam rotates along an axis orthogonal to an axis of rotation of the pinion gear.

The flossing devices can also include an actuation switch to initiate horizontal vibrational movement of a length of floss. The flossing devices also can be water-resistant.

The flossing devices can include a head unit that includes a pair of spaced-apart arms extending to a distal end to hold a length of floss between the pair of arms. The head unit includes a cover that is removed to expose floss for use. The head unit can be detachable from the handle and replaceable with another head unit. In some example embodiments, the handle can include a single switch to initiate vibration of floss during flossing.

Additionally, the flossing devices can include a microcontroller in the handle to operate the drive motor and an indicator cue to indicate one or more conditions selected from the group of a time to change the floss, a low power level, and an incomplete connection between the head unit and the handle.

In one example embodiment, the handle of the inventive device includes a drive motor, a vibration motor, and a power unit. The drive motor advances the floss in the device so that the user flosses with clean floss. The vibration motor provides a vibratory movement to the floss so that the floss is more effective cleaning the teeth. In an embodiment of the invention, the vibration motor is an eccentric rotating mass (ERM) vibration motor (e.g., counter-weight motor) which provides a vibratory effect to the exposed length of floss. In another embodiment of the invention, the vibration motor is a counterweighted vibration motor that provides a vibratory effect to the exposed length of floss.

In a further embodiment of the invention, the handle can include a microcontroller to operate the drive motor and the vibrational motor. The flossing device utilizes various waterproofing or water-resisting features so that water or liquid used to rinse or clean the device does not enter the interior floss storage compartment(s) or the power circuitry in the handle.

Advantageously, the separate drive and vibration motors allow for a greater customization of the usage of the flossing device compared to conventional single motor devices that both advance and vibrate the floss. The separate motors permit the user to advance floss without vibrating it, or vibrate floss without advancing it, and thereby reduce floss waste and unnecessary motor activity.

A single drive gear is used to engage the internal gear assembly, which includes a floss supply gear and a floss take-up gear. The drive gear engages the floss supply gear or the floss take-up gear, and the floss gears are directly coupled to each other or are coupled via an intermediary gear (further described below) to have a gear offset or a non-unity gear ratio so that the gear teeth are not in a 1:1 ratio. The gear offset allows one gear to turn at a rate that is faster than the other gear. This offset maintains the floss under a consistent tension to keep it taut while the device is being used. As an additional advantage, the gear offset accounts for the spooling of used floss on the floss take-up gear. That is, as floss is being used, the diameter of the new floss on the floss supply gear will decrease while the diameter of the used floss on the floss take-up gear will increase in diameter. This change in the diameters of the floss on the respective gears otherwise would cause an offset which would reduce tension, but the gear offset of the supply and take-up gears in the invention accounts for this offset and actively corrects the floss tension, so the user does not notice a slackening of the floss.

The power unit can be a convenient source of electrical power, such as a battery providing electromotive force to the flossing device. The battery can be rechargeable or disposable, depending upon the particular implementation of the invention. Alternatively, the power unit can be a connection to a domestic power source, such as a convenience outlet to which the device is connected via a power cord or cable during use. In certain embodiments, a rechargeable battery can be charging while the device is in use and connected to an electrical convenience outlet. In certain embodiments, a light on the body of the head unit of the device will indicate a low battery.

In one embodiment, a head unit of the invention includes a drive gear driven by the drive motor located in the handle, a floss supply gear operationally connected to the drive gear, where the floss supply gear accommodates a supply spool of fresh floss. The head unit also includes a floss take-up gear operationally connected to the floss supply gear, where the floss take-up gear accommodates a take-up spool for used floss. The floss supply gear and the floss take-up gear have a gear ratio such that the floss is under a consistent tension during use. The head unit also includes a housing that defines a path for floss between supply spool and take-up spool. The housing provides an exposed length of floss. In such an embodiment, the head unit contains mechanical parts and does not contain electronic components.

The drive gear is a structure that drives the floss supply and take-up gears to advance the floss in the device. In an example embodiment of the invention, the drive gear is a worm gear having a shaft that fits into a cavity in the handle and is powered by the drive motor.

In an example embodiment of the invention, the handle includes a charging interface for charging the power unit. For example, the charging interface can be a micro-USB port, an electrical socket, or other socket for connection to a power supply such as a domestic electrical convenience outlet. The charging interface can accept a direct electrical connection to a power source such as a USB drive or electrical outlet. Alternatively, the device can include an internal electrical converter to convert an electrical supply to a voltage which is usable by the flossing device. A power cable can include an in-line converter which converts an input voltage to an output voltage usable by the device. The flossing device can be configured as a dual voltage device to connect to both 110-120V and 220-240V domestic power sources, or to other power sources as can be desirable.

The flossing device can include additional gears which cause the floss supply and floss take-up gears to operate. For example, the flossing device can include a reducing gear or other gear that operationally connects the drive gear with the floss supply and/or floss take-up gears to increase or decrease the rate at which any of the gears turn.

In an example embodiment of the invention, the flossing device can include one or more actuators implementing various functions. For example, the flossing device can include an actuator to cause the floss to vibrate. Depending upon the particular implementation of the invention, the actuator can be a single switch or button which has, for example, multiple detents or settings to enable multifunctional uses. These multiple functions can be implemented using a single actuator featured on the flossing device. The actuator can be configured to have the drive motor vibrate the floss at a single setting (e.g., vibrating speed or strength), at a plurality of vibrational settings (e.g., with different vibrating speeds or strengths), or at other settings along a continuum.

The flossing device is water-resistant and/or waterproof to prevent moisture from entering the device or damaging electrical or other internal components. Components of the flossing device can be configured with user-replaceable components such as a battery, head unit, neck, handle, and other components.

The floss in the head unit of the flossing device can be conventional waxed or unwaxed floss, dental tape, PTFE floss, and other kinds of floss configured to work with the components of the flossing device. In addition, the floss can be flavored, colored, and have a particular texture or smoothness to provide a particular sensory or cleaning experience to the user.

The flossing device can include a single-direction movement mechanism that is configured to prevent floss from moving in a reverse direction. In some example embodiments, a mechanism is implemented in the form of a reverse-lock mechanism on one or more of the gears in the head unit, although other implementations are possible and within the scope of the invention.

In an embodiment of the invention, the housing of the head unit includes a pair of arms having distal ends to hold the floss. The pair of arms can be moveable from a closed configuration where the distal ends of the arms enclose the path of floss to prevent contamination of previously unused floss, to an operational configuration wherein the distal ends of the arms separate to open an exposed length of floss for use. The arms can also have a fixed configuration to hold the floss in place. The housing of the head unit can also include a cover that is removed by detaching, sliding, or otherwise moving the cover to expose floss for use. After flossing is complete, the cover can be reaffixed to the head unit so that the floss remains clean and sanitary for subsequent use.

The head unit can be detachable from the handle/neck and replaceable with another head unit that can include unused floss to allow for replacement of fresh floss once a floss head unit is used for a certain period of time. Such an embodiment allows a user to replace the used floss in the device with a fresh supply of floss. The head unit and handle can each have complementary locking features that cooperate to lock and unlock the head unit to the handle. Locking features can be implemented as snap fit mechanisms, buttons, tabs, or other locking elements.

The flossing device can use an indicator cue to indicate one or more conditions affecting use. For example, the flossing device can provide an indication of a need for a fresh floss head unit, a low power level, and/or an incomplete connection between the head unit and the handle. An indicator cue can be implemented, for example, using a blinking warning light, LEDs, tone, vibration, and other visual, audio, or sensory cues. In one example embodiment, the indicator cue utilizes a plurality of LEDs, and each LED can indicate a different condition. Some other indications can track user flossing habits or progress, or indications that the device is updating or connecting to another device to upload a history of its use.

To maintain the floss inside the flossing device in a hygienic manner, the flossing device can include a sanitizer reservoir that applies sanitizer to used floss to help eliminate bacteria on the floss as well as to prevent bacterial growth. The sanitizer can be a liquid or a gel, for example, and can include one or more disinfectant, antiseptic, bactericidal, and/or bacteriostatic agents. In one example, alcohol and/or quaternary ammonium compounds are used. The sanitizer reservoir can be in the head unit and apply sanitizer to the used floss at an appropriate position in the device, such as when the used floss re-enters the head unit. In other embodiments, the sanitizer reservoir can extend from the handle or neck to the head unit to apply sanitizer to the floss. The sanitizer can be applied to the used floss by a convenient method, such as by running the floss against a sponge moistened with the sanitizer. In other embodiments, the sanitizer can be in the form of an ultraviolet lamp that shines ultraviolet light on the device to eliminate bacteria. The ultraviolet lamp can be a UV-C diode that disinfects the floss by killing bacteria.

### BRIEF DESCRIPTION OF THE DRAWINGS

FIGS. 1A-1G illustrate exemplary embodiments of flossing devices in accordance with the invention.

FIGS. 2A-2C illustrate perspective views of a head unit and a neck of an exemplary flossing device shown in FIGS. 1A-1G.

FIGS. 3A-3C illustrate perspective, front, and rear views of a head unit and neck of an exemplary flossing device shown in FIGS. 1A-1G.

FIGS. 4A-4C illustrate perspective, top, and bottom views of a head unit of an exemplary flossing device shown in FIGS. 1A-1G.

FIG. 5 illustrates an exploded view of a flossing device in accordance with the invention.

FIGS. 6A and 6B show cross-sectional views of a flossing device in accordance with the invention.

FIG. 7 illustrates a front perspective view of a handle and neck of an example flossing device with a housing of the handle removed.

FIGS. 8A-8D illustrate an example drive mechanism in a handle of a flossing device in accordance with the invention.

FIGS. 9A-9C illustrate additional views of an example drive mechanism in a handle of a flossing device in various positions.

FIG. 10 illustrates a front perspective view of a stem of a drive mechanism of a handle of a flossing device in accordance with the invention.

FIGS. 11A-11C show an example flossing device of FIGS. 1A-1G with a wall mount.

FIG. 12 illustrates another exemplary embodiment of a flossing device in accordance with the invention, in which floss supply and floss take-up gears are turned by a worm gear interfacing with the handle of the device.

FIG. 13 illustrates components located in the handle of the exemplary flossing device shown in FIG. 12.

FIG. 14 shows another embodiment of a flossing device according to the invention, in which floss supply and take-up gears are turned by a pinion gear, and an actuator unlocks and activates the device.

FIG. 15 shows another embodiment of a flossing device according to the invention, in which a slider unlocks the supply gear and activates the device.

FIG. 16 shows another embodiment of a flossing device according to the invention, in which a cam and reverse lock prevent advancement of floss in the device.

FIG. 17 illustrates another embodiment of a flossing device according to the invention, in which the floss is advanced manually via a thumb wheel.

FIGS. 18A-18F illustrate top, front, sides, rear, and bottom views of a flossing device in accordance with an embodiment of the invention.

FIGS. 19A-19D illustrate various views of a flossing device with a wall mount in accordance with an embodiment of the invention.

FIGS. 20A-20D illustrate various interior views of a flossing device in accordance with an embodiment of the invention.

FIGS. 21A and 22B illustrate various cut-away views of a flossing device in accordance with an embodiment of the invention.

FIGS. 22A-22C illustrate a connection between a handle and head of the flossing device in accordance with an embodiment of the invention.

FIGS. 23A and 23B illustrate various views of distal ends that hold floss of a head of a flossing device in accordance with an embodiment of the invention.

### DETAILED DESCRIPTION

Embodiments of the invention will now be described with reference to the Figures, where like reference numerals refer to like elements. Dimensions of components may be provided in imperial and/or metric units and are intended to be illustrative and not limiting, and all dimensions are to be understood as approximate. Curved arrows show the general direction of movement of the gears and cogs in the Figures. Unless otherwise qualified, the term “a” is intended to introduce a single component or a plurality of components.

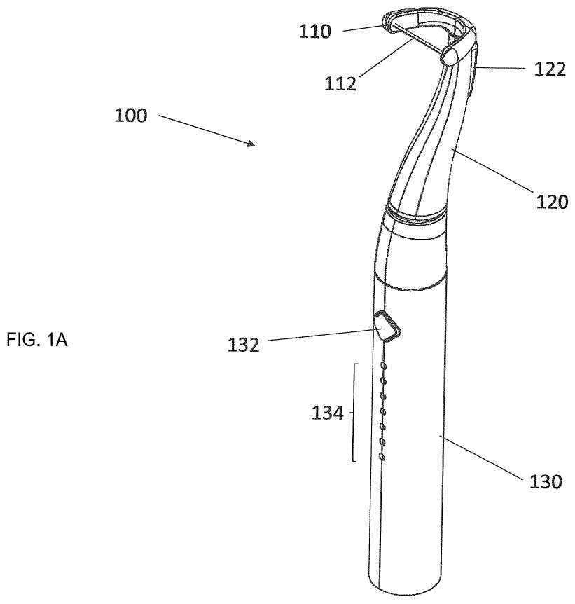

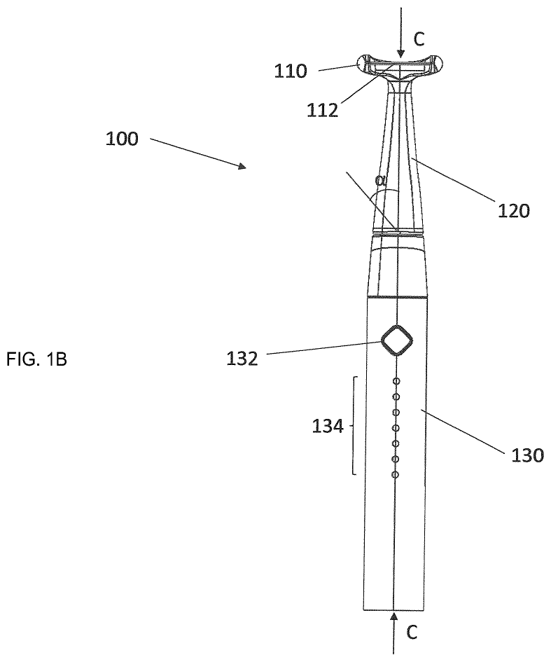

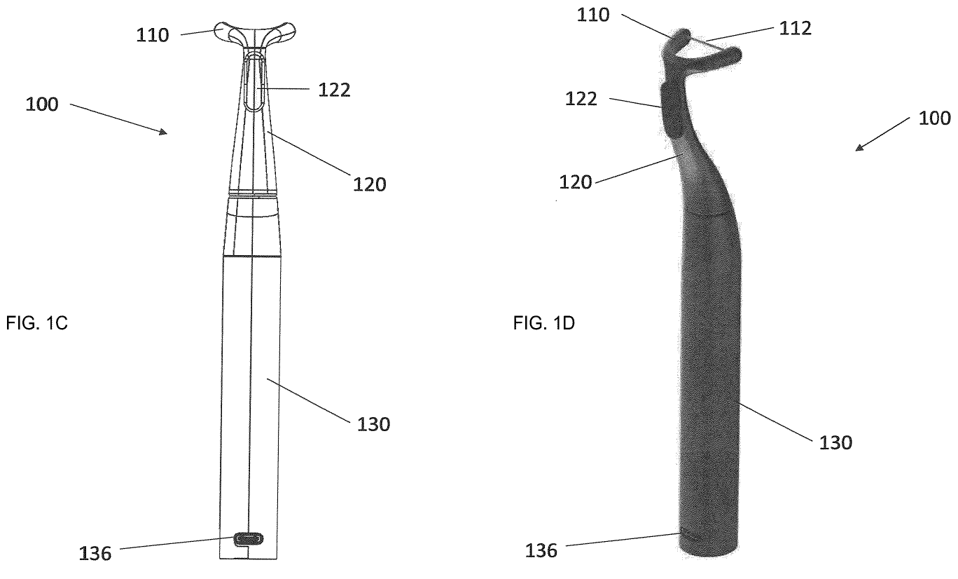

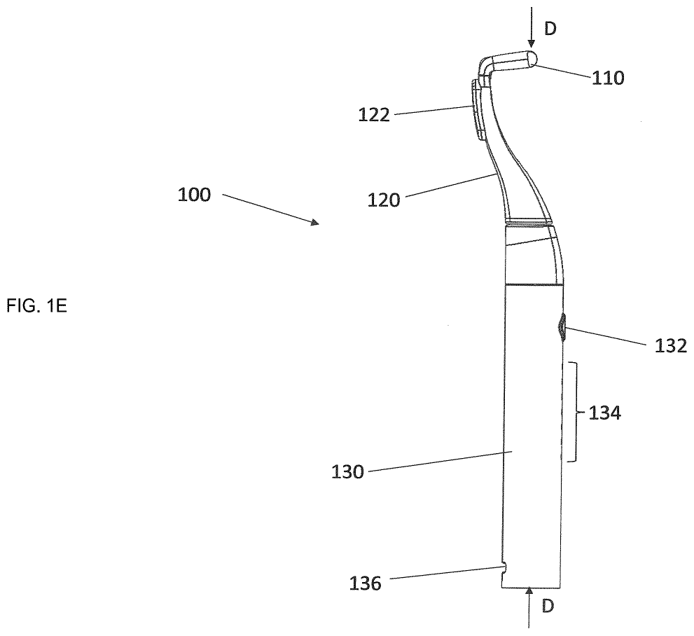

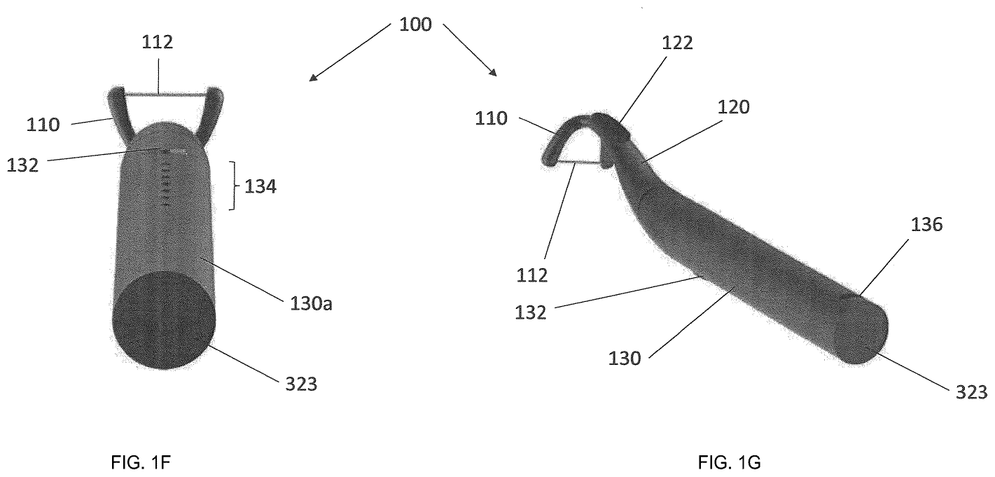

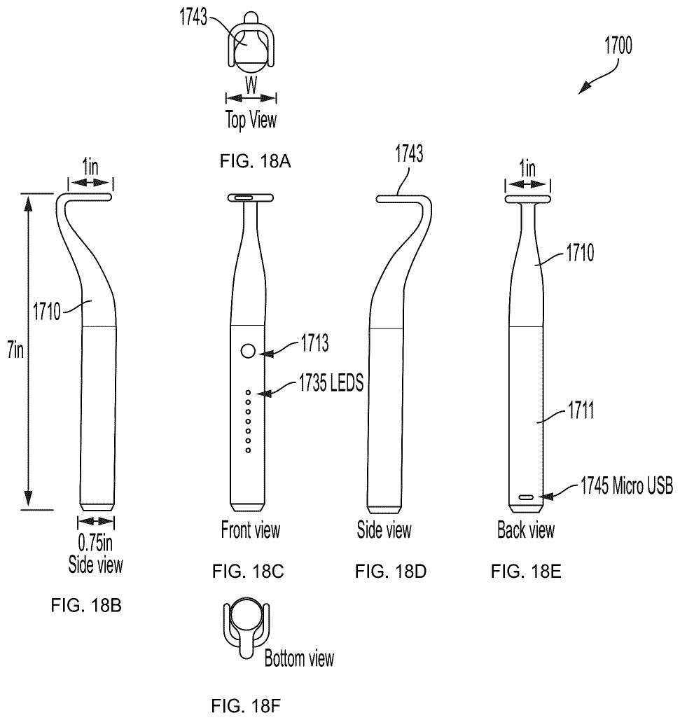

FIGS. 1A-1G illustrate views of an exemplary embodiment of a flossing device 100 in accordance with the invention. Specifically, FIG. 1A illustrates a front right perspective view of a flossing device 100. FIG. 18 illustrates a front view of the flossing device 100 of FIG. 1A. FIG. 1C illustrates a rear view of the flossing device 100 of FIG. 1A. FIG. 1D illustrates a left rear perspective view of the flossing device 100 of FIG. 1A. FIG. 1E illustrates a left side view of the flossing device 100 of FIG. 1A FIG. 1F illustrates a bottom front perspective view of the flossing device 100 of FIG. 1A, and FIG. 1G illustrates a right-rear perspective view of the flossing device 100 of FIG. 1A.

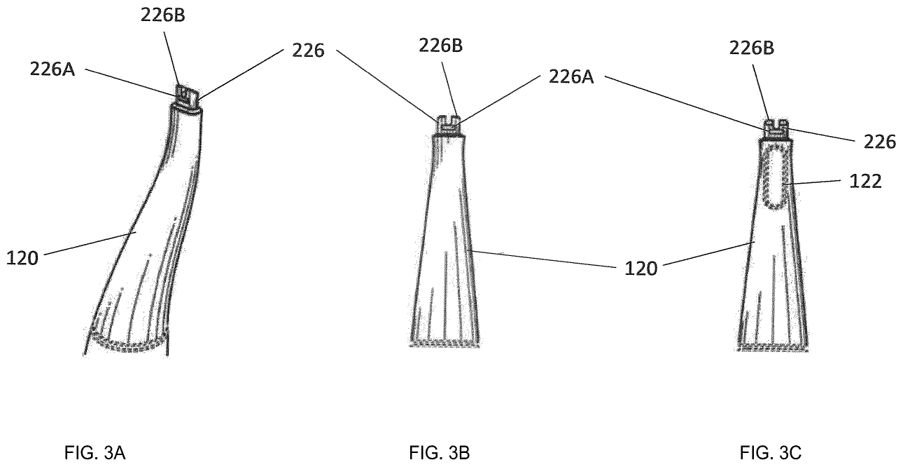

The illustrated flossing device includes a head unit 110, a neck 120, and a handle 130. The head unit 110 is joined to the neck 120 by a locking mechanism (as shown in FIG. 3 below). The head unit 110 is generally in the shape of a semi-circle having a flossing head unit 110 that exposes a length of clean floss 112 for use between two distal ends of the semi-circle that are arms extending from the neck/handle of the flossing device 100. The head unit 110 may have a cover (not illustrated) which covers the flossing head unit 110 when not in use to prevent contamination of the floss 112. The illustrated embodiment has a flossing head unit width of about 1 inch (2.5 cm) and an overall length of about 7 inches (about 18 cm).

To use the floss 112 held in the head unit 110 of the flossing device 100 in a hygienic manner, the flossing device 100 may include a reservoir (not shown) of a sanitizer, which is configured for application to used floss 112 to help eliminate bacteria on the floss 112 as well as preventing bacterial growth. The sanitizer may have any convenient form, for example, a liquid or a gel, and contain one or more disinfectant, antiseptic, bactericidal and/or bacteriostatic agents, for example (but not limited to), alcohol and/or quaternary ammonium compounds. The sanitizer reservoir (not shown) may be located in the head unit 110 and apply sanitizer to the used floss at any appropriate position in the device, such as when on the head unit 110. In other embodiments, the sanitizer reservoir (not shown) may extend from the handle 130 or neck 120 to the head unit 110 to apply sanitizer to the floss 112. The sanitizer may be applied to the used floss 112 by any convenient method, such as by running the floss against a sponge (not shown) moistened with the sanitizer. In other embodiments, the sanitizer may be in the form of an ultraviolet lamp which shines ultraviolet light on the device 100 to eliminate bacteria. In other embodiments, the head unit 110 includes a cover (not shown) that may include the ultraviolet lamp or act to prevent contamination when the flossing device 100 is in storage.

In some embodiments, the housing of the head unit 110 includes a pair of arms that may be moveable from a closed configuration wherein the distal ends of the arms enclose the path of floss to prevent contamination of previously unused floss, to an operational configuration where the distal ends of the arms separate to open the exposed length of floss for use. In some embodiments, the arms are in a fixed configuration to hold the floss in place. The housing of the head unit 110 may further include a cover that is removed by detaching, sliding, or otherwise moving the cover to expose floss for use. After flossing is complete, the cover can be reaffixed to the head unit so that the floss remains clean and sanitary for subsequent use.

When flossing with traditional string floss, a conventional technique is to bend the floss into a C-shape around a tooth while sliding the floss up and down a tooth to the gum line. This process would allow for both teeth on either side of the space in which the floss is applied to experience cleaning by the floss. According to dental professionals, one of the shortcomings of conventional floss picks is that the floss is so tight that it is impossible to create the c-shape around each tooth. The head unit 110 was designed to incorporate additional “give” such that the floss head can create a C-shape around each tooth to better replicate flossing by hand.

The handle 130 of the exemplary flossing device 100 shown in FIG. 1A includes an actuation switch 132 that is a button or other actuator for initiating operation, powering on/off the flossing device 100, setting a vibrational strength, and/or other functionality. The actuation switch 132 can be configured with several detents so that pressing the switch 132 once will vibrate the floss 112, while another detent may set the vibration strength, or reset a floss change timer, for example. Alternatively, the switch 132 can be configured so that pressing the switch 132 once will initiate vibration, and pressing the switch multiple consecutive times will set the vibrational strength. There may be a continuum of vibrational limits so that the more times the user presses the switch 132, the stronger or weaker the vibration of the floss 112. These vibrational selections can be configured by using switch(es) 132 or an alternative selection mechanisms (e.g., a phone application selection).

The handle 130 has a cylindrical shape that can house the components in a form factor that allows a user to grasp the main cylinder 130a (as shown in FIG. 1F) of the handle 130. In some embodiments the handle 130 is made of aluminum. In other embodiments, the handle 130 is made of other non-liquid permeable materials to hold the components of the flossing device 100, such as a carbon fiber or plastics. In other embodiments, the handle 130 includes a grip for a user to better grasp the flossing device 100.

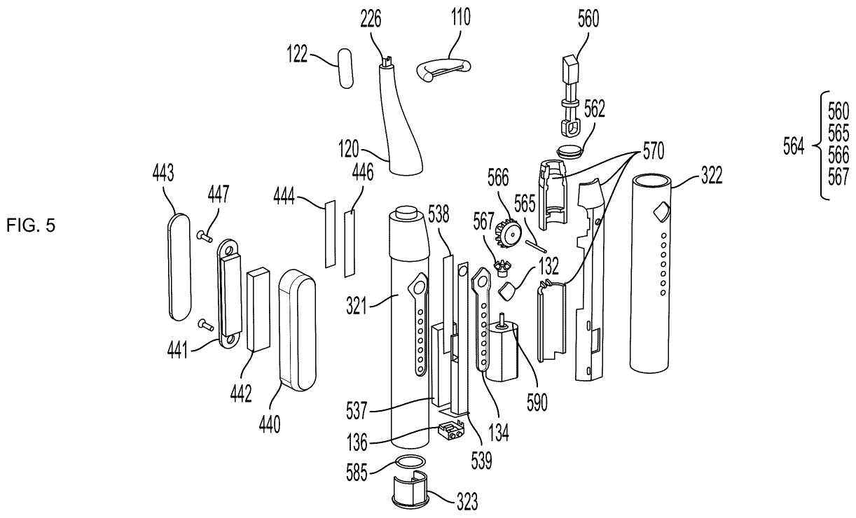

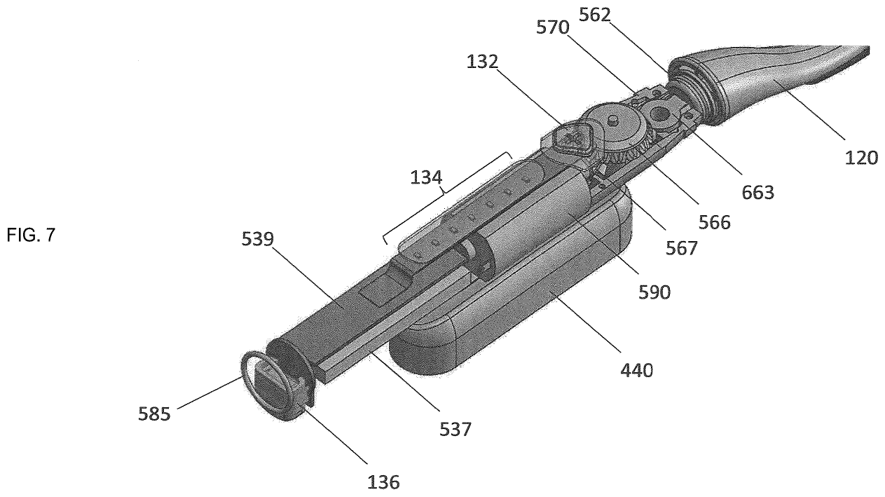

In FIG. 1A, the exemplified flossing device 100 has a set of seven LEDs 134 that are indicators that can be configured to show various functions. These indicators 134 can provide cues for the amount of power left in the power source 537 (seen in FIGS. 5 and 7 below), the amount/degree of vibration, or for tracking daily usage such as one LED for each day of the week or different color indicators for each day. For example, Monday may be green, Tuesday may be pink, Wednesday may be blue, etc. These indications can also be selected or created by a user from the device or through an application to which the device may connect.

The flossing device 100 can include a conventional micro-USB, USB-C, or other charging interface 136. A compatible micro-USB, USB-C, or other charging interface cable can be included in an optional kit provided to customers by the manufacturer or users may obtain charging cables from a retailer. The use of an industry-standard charging interface, such as a micro-USB or USB-C, allows users to use their own charging cables, to connect their flossing devices to a computer or smartphone for device updates, and to obtain a record of the device's use, such as daily flossing time. Further, the charging interface 136 can include a water resistant or waterproof cover to prevent water or other liquids from affecting the power source 537 (seen in FIGS. 5 and 7, and described below). In other embodiments of the invention, an alternative charging interface, such as a USB interface, a proprietary interface, or other interfaces, can be used. In other embodiments, wireless charging interfaces (e.g., magnetic) can be used.

The configuration of the flossing head unit 110 having a small semi-circular arm shape allows a user to conveniently insert the flossing device 100 in his or her mouth and to maneuver the floss in between and around teeth. The configuration and appearance of the flossing head unit 110, and the flossing device 100 in general, depends upon the particular implementation of the invention. For example, smaller semi-circular arms can be used for children. The flossing head unit 110 also can include a cleaning tool (not illustrated), such as a scraper, to prevent food debris, plaque, and excess moisture removed by the floss 112 from entering the flossing head unit 110 to minimize unhygienic conditions inside the flossing device 100. Additionally, the user can use water to remove debris/plaque from the floss during and after use.

The non-electrical components of the device 100 can include plastic/injection molded components. These components can be made from plastics, including acrylonitrile butadiene styrene (ABS), polypropylene (PP), and other bioplastic, such as polylactic acid (PLA), poly lactide, polybutylene terephthalate (PBT), and closed cavity bag molding (CCBM), which includes a mix of PLA and PBT that is biodegradable and compostable. Other biodegradable and compostable plastic with enough strength to provide the structure for the device 100 can also be used.

As seen in FIGS. 1F and 1G, the handle 130 includes a bottom cap 323 and an aluminum outer shell 321. The housing 321 is made of aluminum to prevent corrosion and to provide a lighter weight, yet strong material. In some embodiments, the housing 321 can be made of other materials that are non-corrosive, are strong, prevent liquid ingress, and are lightweight, such as carbon fiber or plastics.

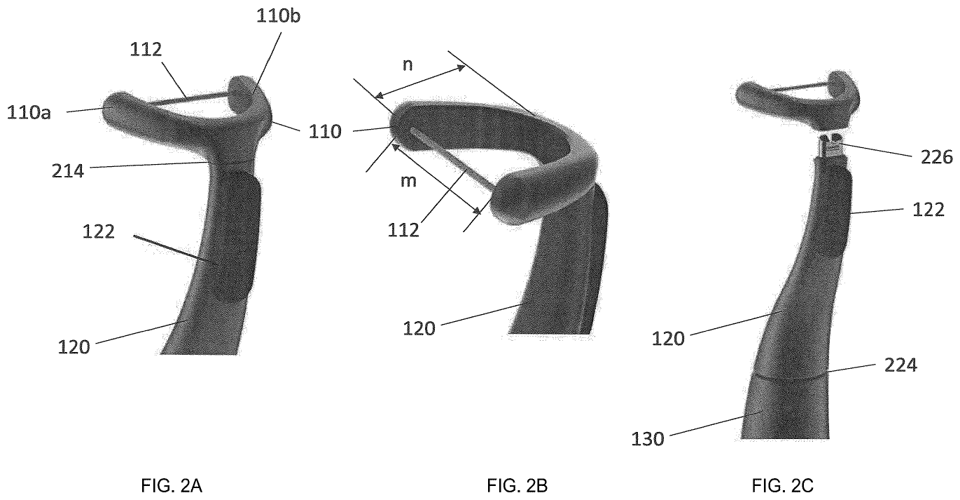

FIGS. 2A-2C illustrate perspective views of a head unit 110 and neck 120 of the exemplary flossing device 100 shown in FIGS. 1A-1G. Specifically, FIG. 2A illustrates a front perspective view of the head unit 110 and neck 120 of the flossing device 100. FIG. 2B illustrates a front perspective view of the head unit 110 and neck 120 of the flossing device 100. FIG. 2C illustrates a rear perspective view of the head unit 110 and neck 120 of the flossing device 100 in a separated state. The head unit 110 can include rounded surfaces and a semi-circular wishbone shape with distal arms (110a and 110b) extending from the neck 120. The rounded surfaces prevent irritation and injury to the user's mouth. The arms 110a and 110b include a depth, n, to provide enough space to allow the floss 112 running between the arms 110a and 110b to enter tight spaces between teeth without being impeded by the teeth. Further, the width m between the arms 110a and 110b limit irritation to a user's cheek and tongue surfaces.

FIGS. 3A-3C illustrate various views of a neck 120 of the exemplary flossing device 100 shown in FIGS. 1A-1G. Specifically, FIG. 3A illustrates a front right perspective view of the neck 120 of the flossing device 100, FIG. 3B illustrates a front view of the neck 120 of the flossing device 100, and FIG. 3C illustrates a rear view of the neck 120 of the flossing device 100.

As shown, the neck 120 of the flossing device 100 can include a bite pad 122. The bite pad 122 can be made of any number of materials including silicone or rubber to allow a user to aid flossing by biting down on the bite pad 122 with opposing teeth and gums. The bite pad 122 provides the user with greater control of the floss 112, allowing them to comfortably move the floss 112 between tightly spaced teeth, and offering much greater control in doing so, relative to manual flossing. For example, when flossing the bottom set of teeth, a user may bite down on the back of the neck 120, generally on the bite pad, and push the floss 112 further in between the gums and/or teeth. In some example implementations, the bite pad 122 is approximately 2 mm thick. The bite pad 122 can be attached to the neck 120 with adhesives or a fastener.

The bite pad 122 provides leverage for a user to dislodge the device from in between teeth more easily. That is, the bite pad 122 is instrumental in helping the device 100 get in and out of teeth. As an example, a user can push down on the bite pad 122 with their top teeth in order to help the device push through the tight space between bottom teeth. The bite pad 122 helps control pressure and prevents harming the gums by forcing the floss down and up which is a common occurrence with conventional dental floss or floss picks.

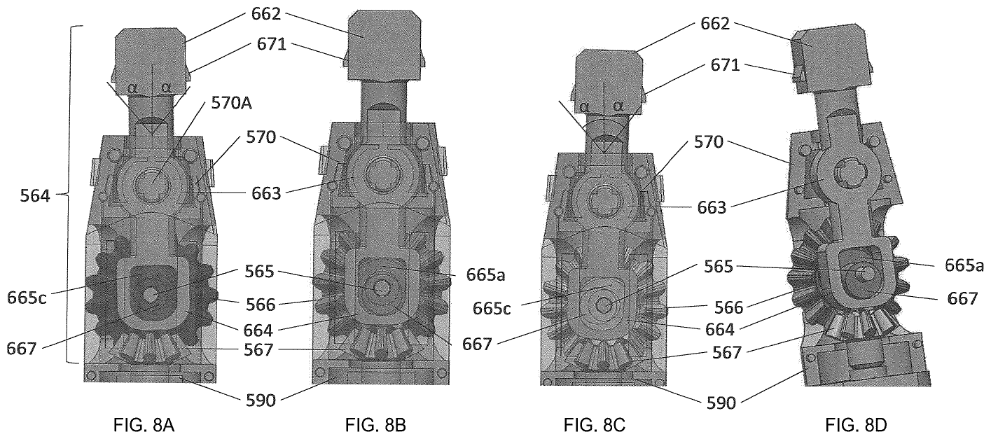

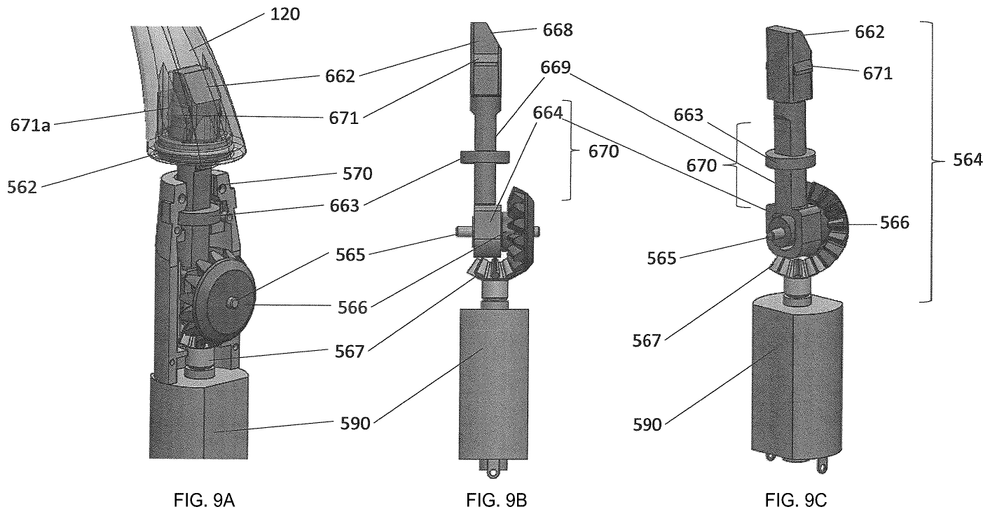

Additionally, the neck 120 is attached to the handle 130 at a neck attachment point 224. The neck attachment point 224 can mate with a head adapter post 662 (as shown in FIGS. 8A-9C below) of the handle 130 with a cavity (not labelled) corresponding to the shape of the head adapter post 662 including a sloped section 668 and snaps 671 to prevent accidental removal of the neck 120 from the handle. The neck 120 has a tapered s-shape with circular cross-sectional shapes that allow the head unit 110 of the flossing device 100 to reach the back of a user's mouth without irritation. In other embodiments, the shape of the neck 120 may have a different cross-sectional shape (e.g., rounded rectangle) and/or can be straight rather than s-shaped, as long as the head unit 110 of the flossing device 100 can reach the back of the user's mouth with ease and without irritation. By using the device, a user's hands/fingers, which are often unsanitary portions of the body, are not used.

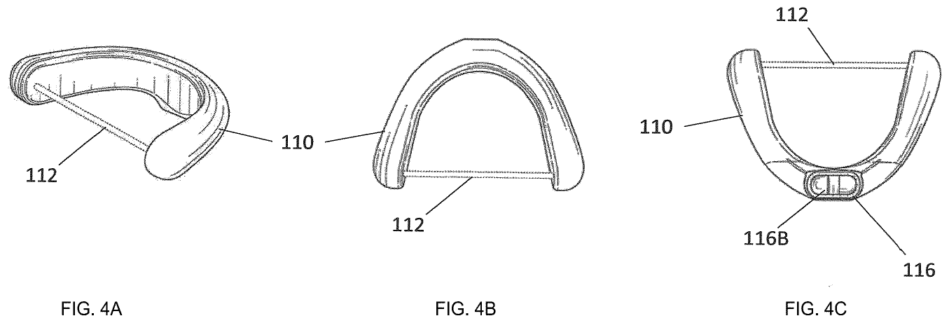

The neck 120 also includes a locking tab 226 that can be used in conjunction with head unit 110 for removing retaining head unit 110. In the illustrated embodiment, the locking tab 226 is made of a stainless steel, however, in some embodiments, the tab 226 can be made of non-deforming, corrosion resistant or non-rusting materials such as aluminum and plastic. The locking tab 226 is asymmetrical from the front to back, which prevents backward placement of a head unit 110 on the neck 120. The locking tab 226 can include protrusions 226A and/or cavities (not shown, such as tabs and slots) for mating with corresponding cavities 116B (seen in FIG. 4C) or protrusions (not shown) respectively in the head unit 110. Such locking tabs 226 are capable of withstanding the removal forces when head units are replaced and when new sanitary floss 112 is accessed for the flossing after/before uses. Further, the locking tabs 226 prevent removal/dislodging of the head unit 110 during normal use. The protrusion 226A, shown in FIGS. 3B and 3C, is a rounded bump that snaps into a cavity 116B of the head unit 110.

FIGS. 4A-4C illustrate various views of a head unit 110 of the exemplary flossing device 100 shown in FIGS. 1A-1G. Specifically, FIG. 4A illustrates a front perspective view of the head unit 110 of the flossing device 100, FIG. 4B illustrates a top view of the head unit 110 of the flossing device 100, and FIG. 4C illustrates a bottom view of the head unit 110 of the flossing device 100.

The head unit 110 of the flossing device 100 has a U-shape and the distal ends of the head hold ends of floss 112. The bottom of the head unit 110 includes a cavity 116 with multiple openings 1166 for mating with the protrusions 226A of locking tab 226 of the neck 120 described above. The distal ends of the head unit 110 have a rounded shape on the outer sides of the head. The rounded shape prevents injury or irritation to a user's mouth when in use. The size and shape of the head unit 110 is largely determined by the size of a user's mouth cavity, and different users may prefer different sizes (e.g., small, medium, large). For example, the width m of the head unit 110 (shown in FIG. 2B) may be 0.5 inches for children with smaller teeth/mouths and 1.5-2 inches for adults with larger teeth/mouths. The head unit 110 is removable and can be discarded after use. In other embodiments, only the floss 112 is removed and replaced on the head unit 110, however the head unit 110 can be removed for easier installation of the floss 112.

FIG. 5 shows an exploded view of the flossing device 100. Again, the main components of the flossing device 100 include the head unit 110, neck 120, and handle 130. The neck 120 and the head unit 110 are discussed above in conjunction with FIGS. 3A-3C and 4A-4C respectively. The handle 130 further includes an interior cavity that is defined by the housing 321. The interior of the cavity of housing 321 includes a volume for a bottom cap 323, O-ring 585 for the bottom cap 323, a power source 537, printed circuit board (PCB) 539 with an actuation switch 132 and indicators 134, an inner chassis 570, a drive motor 590, a drive mechanism 564, an elongated shaft 560, and gasket 562 for the elongated shaft 560 as key components. Further, handle 130 can include a grip cover 322 to the housing 321 made of the same material or a grippier material, such as rubber or silicone that is positioned over the housing 321. The grip cover 322 allows a user to grasp the flossing device 100 more easily and prevents the flossing device 100 from slipping from the user's hands.

The bottom cap 323 and O-ring 585 combine to prevent ingress of liquid from the bottom of the flossing device 100. The cap 323 also prevents the interior components of the handle 130 from being removed from the housing 321. The PCB 539 can also include indicators 134 and an actuation switch 132 described above with regard to FIGS. 1A-1G, for example.

The power source 537 can be a rechargeable power source. In some embodiments, the power source 537 can include one or more disposable batteries, such as conventional AA or AAA batteries, or the flossing device 100 can be plugged into a conventional wall outlet to power the device during use. The power source 537 can be a battery that can be recharged using wireless means such as inductive charging or a cable charging interface 136 described above with regard to FIGS. 1A-1G, for example.

The PCB 539 includes actuation switch 132 and indicators 134, which select and indicate flossing device 100 settings and status. As described above, the indicators can show different vibrational strength settings, time spent flossing, days the flosser was used, and other indications, such as low power and recharging states.

The inner chassis 570 includes cavities (i.e., openings) 570a that help define the degree of movement left-to-right and/or the vibration of the elongated shaft 560. Some embodiments can also include cavities 570a that also allow for front-to-back, up-to-down, and other circular movements to assist with more effective and efficient flossing. The cavities 570a provide both the space (i.e., tolerances) to the left- and right for displacements of the elongated shaft 560 and interface with sidewall spacers 663 (i.e., restrictions) to prevent over-displacement of the head adapter post 662. The cavities in inner chassis 570 provide primarily a left-to-right displacement of around 3 mm total sweep or around 1.5 mm to each side, left and right. The left-right displacement results in a vibration of the head unit 110 and therefore a vibration of floss 112 of the flossing device 100. The sidewall spacers 663 include walls that prevent front-to-back and up-to-down movements.

The drive motor 590 fits within the body of the handle 130 and has a higher torque (for example, between 13 g-cm during max efficiency, and 30 g-cm at max power) to prevent binding by the drive mechanism 564 when the flossing device 100 is in use. The drive motor 590 may run between 4000 and 12000 revolutions per minute (RPM), such as 6000 RPM, for example. However, drive motors 590 at 12000 RPM with higher torques of between 13 and 30 g-cm are also used to prevent the motor from binding or stalling during use. In other example embodiments where ERM, sonic vibration motors, and LRA motors are used, other torque and RPM specifications may be preferred.

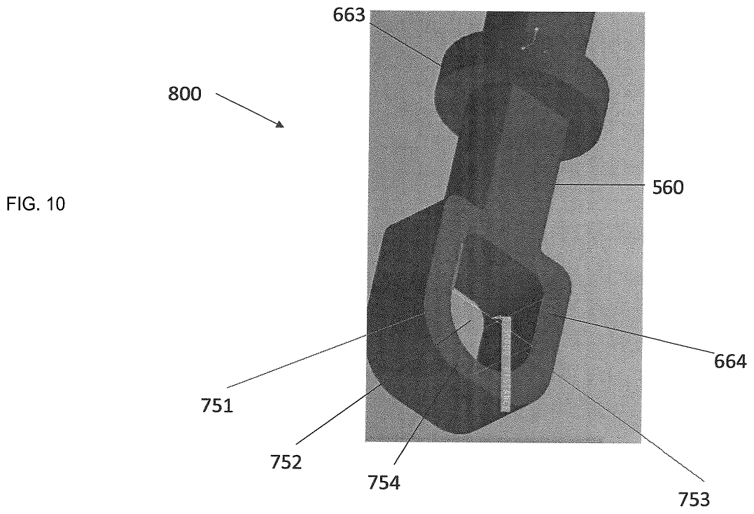

The drive mechanism 564 includes a pinion gear 567 connected to a cam 667 with large gear 566 that turns the cam 667 around an axle 565 of the cam 667 (as shown in FIGS. 8A-8D and 9A-9C below) with large gear 566. The cam 667 with large gear 566 interfaces with the open portion (i.e., eccentric collar 751 shown in FIG. 10 below) of the elongated shaft 560 to vibrate the head unit 110 with the floss 112. The pinon gear 567 is a tapered bevel pinion gear that transfers the rotational force of the drive motor 590 to the large gear 566 and therethrough to the cam 667 and eccentric collar 751 of the elongated shaft 560. This drive mechanism 564 generates the primarily left-to-right movement of the elongated shaft 560 to create the vibration of the floss 112 when in use. The drive mechanism 564 can be made from hard nylon with reinforced additives that make the gears stronger than conventional plastic/ABS to prevent wear over time and provide greater precision movements.

The elongated shaft 560 has three main parts: a head adapter post 662 (as shown in FIGS. 8A-8D and 9A-9C), a sidewall spacer 663 (as shown in FIGS. 8A-8D and 9A-9C), and a drive mechanism interface 664 (as shown in FIGS. 8A-8D and 9A-9C). The head adapter post 662 retains neck 120 as a removable part of the flossing device 100. The sidewall spacer 663 may, in combination with the inner chassis 570, prevent front-back movement and allows left-right movement of a predetermined displacement that is long enough to aid in the flossing, but short enough that a user is not bothered by the movement. The drive mechanism interface 664 connects to the drive motor 590 through a drive mechanism 564 to drive the displacement of the left-right movement.

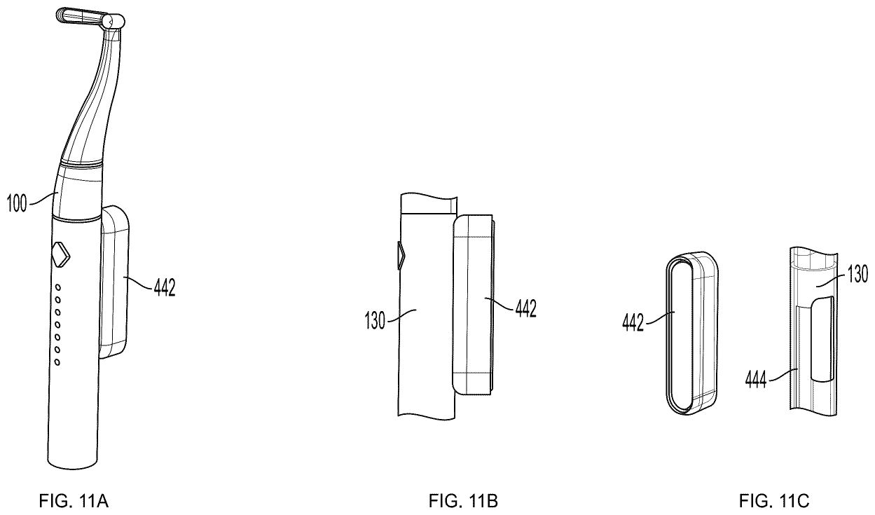

As shown in FIGS. 11A-11C, the flossing device 100 can also include a wall mount that includes a magnet 442 and wall mounted housing. The housing retains the magnet 442 in the wall mount. The wall mount includes a mounting plate and back cover that fastens the magnet into the wall mounted housing with screws, however other methods of fastening may be considered including adhesives and clips. In other embodiments, the magnet 442 can be internal to the flossing device 100 instead of in the wall-mounted housing.

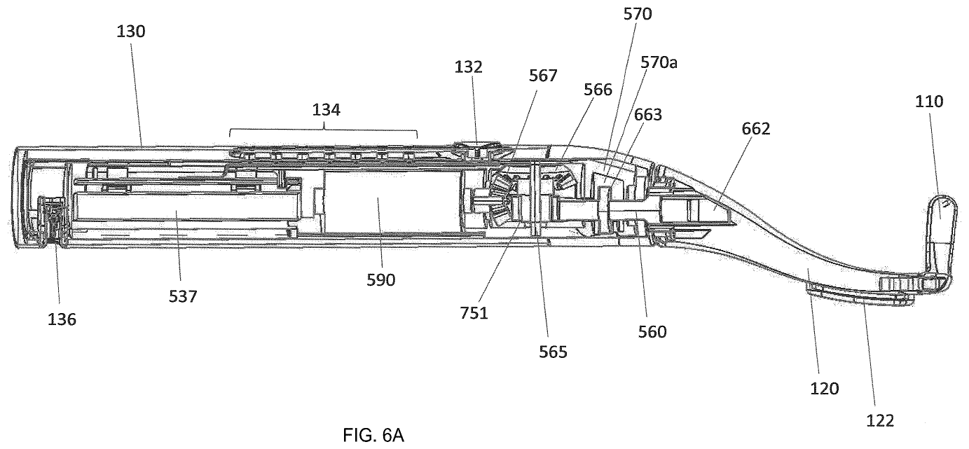

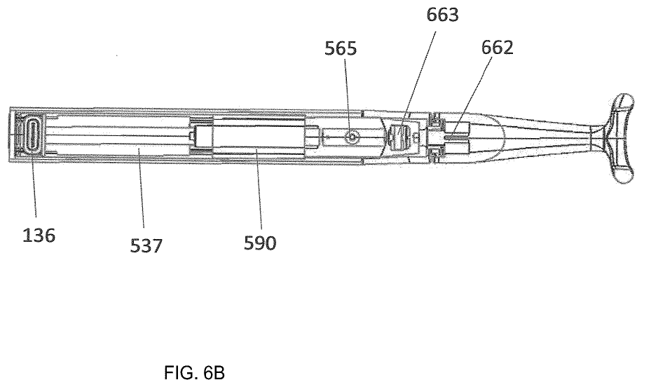

FIGS. 6A and 6B illustrate additional views of the flossing device. Specifically, FIG. 6A illustrates a sectioned side view along the C-C section of FIG. 1B, and FIG. 6B illustrates a sectioned front view along the D-D section of FIG. 1E. FIG. 6A shows a side view of the flossing device 100 including the power source 537, drive motor 590, drive mechanism 564, and elongated shaft 560 with the neck 120 and head unit 110 attached to the top of the elongated shaft 560. The drive motor 590 is attached to the drive mechanism 564 to vibrate the neck 120 and subsequently the head unit 110 of the flossing device 100. FIG. 6B shows a front view with the charging interface 136 as connected to the power source 537. The power source 537 is connected to the drive motor 590 and a PCB 539 with the actuation switch 132 to activate the drive motor 590.

The pinion gear 567 is shown attached to the drive motor 590 and is combined with the cam 667 with large gear 566 and drive mechanism interface 664 to transfer the rotational force from the drive motor 590 into a displacement of the head adapter post 662 of the elongated shaft 560 as shown in FIGS. 1B, 8A, and 8C. The elongated shaft 560 then transfers its movement to neck 120 and head unit 110. Where the elongated shaft 560 retains the neck 120 through head adapter post 662, the elongated shaft 560 displaces due to rotation of the cam 667 with large gear 566 interfacing with the eccentric collar 751 of the drive mechanism interface 664. Further, the elongated shaft 560 includes a sidewall spacer 663 that is secured by inner chassis 570 which prevents over displacement of the elongated shaft 560. The sidewall spacer 663 is placed in the inner chassis 570 and restricts up-to-down and front-to-back movements of the elongated shaft 560.

FIG. 7 illustrates a front perspective view of the handle 130 and neck 120 with the housing of the handle 130 removed. The view shows the location of the O-ring 585, charging interface 136, PCB 539 with microcontroller, power source 537, indicators 134, drive motor 590, actuation switch 132, pinion gear 567, cam 667 with large gear 566, inner chassis 570, and gasket 562 as they would exist in the housing 321 of the handle 130. The view also shows the magnetic wall mount 440 and its location against the handle 130. In other embodiments, the components in the handle 130 could be placed in different locations, as long as the elongated shaft 560 (shown in FIG. 6A) is displaced to the left and right due to the actuation of the drive motor 590. The cam 667 with large gear 566 rotates around axle 565 which forces eccentric collar 664 to move towards a side and causes the vibration of the flosser 100.

The PCB 539 is a microcontroller including an actuation switch 132, and a charging interface 136. The microcontroller (or processor) can be programmed using an integrated development environment (IDE) developed by the microcontroller manufacturer and is typically programmed using a higher-level language such as C++ or Java. A non-limiting list of examples of manufacturers of microcontrollers include Texas Instruments, Arduino, MicrochipTechnology, Atmel, Intel, Sony, and Ubicon.

In certain embodiments, the microcontroller can be programmed to store usage data, such as length of use, and frequency of use, and this information can be downloaded to a computer such as a minicomputer, desktop, laptop, or smart phone via an application program or an app. The program or app can keep a record of the use of the flossing device 100. In certain embodiments, the flossing device's 100 programming can be updated via the charging interface 136, and usage data can be provided to a computer for diagnostic or motivational purposes. In other embodiments, the device 100 may include a Bluetooth or other wireless communication transmission method to allow the device 100 to connect to a smartphone, laptop, or other computing device to provide a user with additional information or features.

In some embodiments, the microcontroller and PCB 539 may be unnecessary. For example, in simpler embodiments, single speed and activation on/off switches that start and stop the device 100 may not need a microcontroller and PCB. In addition to rechargeable power sources, these devices 100 can include non-rechargeable power sources to reduce costs.

The actuation switch(es) 132 on the PCB 539 to cause the drive motor 590 to vibrate the floss 112. The charging interface 136 on the handle 130 accommodates a USB-C interface cable to recharge the battery at a lower voltage than a domestic power line. Other types of connectors or charging interfaces 136 can be used instead of a USB-C depending on the particular implementation of the invention, such as micro-USB and lightning connectors. The charging interface 136, as seen above, may also be used for downloading tracked information or updating the firmware of the flossing device 100. In other embodiments, the flossing device 100 may wirelessly communicate with a software application used on another device to activate or select settings for the flossing device 100.

FIGS. 8A-8D illustrate views of the drive mechanisms 564 in the handle of the flossing device as the drive mechanism is in operation. Specifically, FIG. 8A illustrates a rear view of the drive mechanisms 564 of the handle 130 of the flossing device 100 with the cam 667 in a right displaced position, FIG. 8B illustrates a rear view of the drive mechanism 564 of the handle 130 of the flossing device 100 with the cam 667 in a neutral bottom displaced position when the elongated shaft 560 has moved to its neutral (in line with the handle) position, FIG. 8C illustrates a rear view of drive mechanism 564 of the handle 130 of the flossing device 100 with the cam 667 in a left displaced position, and FIG. 8D illustrates a rear perspective view of the drive mechanism 564 of the handle 130 of the flossing device 100 with the cam 667 again in the bottom displaced position, however in a state where the elongated shaft 560 is just returning from the left position. FIGS. 8A-8C show the cam of the cam 667 with large gear 566 in different positions which results in a displacement to the left-to-right of the elongated shaft 560. These different positions provide the vibrational left-to-right movement of the flossing device 100 head unit 110. FIG. 8D shows the cam in the same position as FIG. 8B.

As shown in FIGS. 8A-8D, the elongated shaft 560 has a differently shaped sidewall spacer 663 than in the sidewall spacer 663 of FIGS. 5, 6A, 6B, 9A-9C, and 10. The sidewall spacer 663 of FIGS. 8A-8D has a donut hole shape, and the sidewall spacer 663 of FIGS. 5, 6A, 6B, 9A-9C, and 10 has a cylinder shape. In any case, the sidewall spacer 663 in conjunction with the open area of inner chassis 570 limits rotation of the elongated shaft 560 to displacement to the left-to-right and prevents up-to-down and front-to-back movement. In this case, the sidewall spacer 663 is in a ring shape and accepts a protruding portion 570A of the inner chassis 570 in the center. The ring shape allows rotation along the inner chassis 570.

The drive mechanism 564 includes the pinion gear 567, the cam 667 with large gear 566, axle 565, inner chassis 570 of the housing 321 and elongated shaft 560. These components, except the inner chassis 570, are also shown in FIGS. 9A-9C below. Other contemplated drive mechanisms 564, which can be used in other embodiments, include mechanisms that use ERM and sonic vibration motors, as well as counterweight motors. The drive mechanism 564 includes the cam 667 and drive motor 590 (as seen in FIGS. 9A-9C) under the constraints of size and shape provided to fit a user's hand and mouth.

The pinion gear 567 is driven by the drive motor 590 (also see FIGS. 9A-9C). The pinion gear 567 has a hypoid bevel and has a revolved hyperboloid shape. As the pinion gear 567 rotates, the cam 667 with large gear 566 rotates around axle 565. The rotational axis of the axle 565 and cam 667 with large gear 566 is orthogonal to the rotational axis of the pinion gear 567. The gear ratio between the pinion gear 567 and large gear 566 is approximately 1:2. Such a gear ratio results in higher torques to prevent binding of the drive mechanism 564 when in use. In other embodiments, the gear ratio may include 8:15 or 1:1.875.

The cam 667, as best seen in FIG. 8D, interfaces/touches the interior surface edges 753 of eccentric collar 751 (as shown in FIG. 10). Because the cam 667 is touching the lower interior surface edge 752 of the eccentric collar 751 and creates gap 665a, (as shown in FIGS. 8B and 8D), the elongated shaft 560 is in a neutral state, i.e., the longitudinal axis of the handle 130 runs parallel to the longitudinal axis of the elongated shaft 560. In FIGS. 8A and 8C, the cam 667 touches the right and left sides of the interior surface edge 752 respectively. This slightly rotates the elongated shaft 560 by a rotational angle α and subsequently displaces the head adapter post 662 by around 1.5 mm in the opposite direction (i.e., the cam 667 touching the right side of the interior surface edge 752 displaces the post 662 to the left by 1.5 mm (see FIG. 8A) and the cam 667 touching the left side of the interior surface edge 752 displaces the post 662 to the right by 1.5 mm). The cam 667 is off-center from the axle 565 and provides the above-described displacement.

Gap 665c surrounding the cam 667 prevents the drive motor 590 from binding when the neck 120 is pushed all the way to the side, as seen in FIGS. 8A and 8C. The gap 665c provides some space/tolerance above and below the lower interior surface edge 752 and reduces a stronger/harsher left-right movement during displacement. When tolerance/space is low in the gap 665c, the left-right displacement is stronger and thus harsher for users. The tolerance/space of the gap 665c also protects the drive motor 590 from stalling by allowing the drive motor to continually spin, even when compressed to one side. Because the lower interior surface edge 752 is in a box-like shape with a slightly rounded end on one side, the cam 667 touches the lower interior surface edge 752 with less physical contact than a circular-shaped lower interior surface edge 752. The minimal contact and additional gap between the side of the cam closer to and/or touching the lower interior surface edge 752 results in more space to continue to allow movement of the drive motor 590 so that the user can continue flossing with vibration action even when high levels of force are applied to any direction of the floss head unit 112/neck 120/device 100 that might bend or flex the device and result in binding or stalling of the drive motor 590.

FIGS. 9A-9C illustrate views of the drive mechanism 564 in various positions in the handle 130 of the flossing device 100. Specifically, FIG. 9A illustrates a front perspective view of the drive mechanism 564 of the handle 130 of the flossing device 100 with the neck 120 attached, FIG. 9B illustrates a side view of the drive mechanism 564 of the handle 130 of the flossing device 100, and FIG. 9C illustrates a back perspective view of drive mechanism 564 of the handle 130 of the flossing device 100. FIG. 9A shows the elongated shaft 560 mated with both the neck 120 and placed within the inner chassis 570. The elongated shaft 560 is mated to the neck 120 with a sloped design on the head adapter post 662. This allows users to know which orientation the neck 120 should be placed in and because of the curve and narrowing in the neck 120, allows the top of the head adapter post 662 to extend into the neck 120 even as the neck 120 curves and narrows.

The specific angles and curvature of the neck 120 allow the device 100 to reach every part of the mouth with ease. Molars are the number one location for cavities and frequently require painful and costly root canals. The most difficult location in the mouth to reach with conventional dental floss and floss picks is the molars. The specific angles and curvature of the neck 120 was honed after hundreds of prototypes. The specifically identified curvature aids in making cleaning of the molars easy and efficient. The specifically identified angle of the neck 120 aids in the head reaching every crevice of a user's teeth and was designed to perfectly fit around an average tooth to provide optimal cleaning.

As seen in FIG. 9A, the neck 120 is snap-fit to the head adapter post 662, which prevents inadvertent removal of the neck 120 from the handle 130. The snap fitting 671 includes a taper or ramp 671a that allows easier placement of the neck 120 on the post 662 but uses a catch to prevent accidental removal. Below the snap fitting 671 is a gasket 562 that allows movement of the neck 120 from the handle 130 but prevents ingress of liquid into the handle 130. The gasket 562 can also influence movement of the neck 120 in all directions but will not prevent left-right movement. In some embodiments, the snap fitting 671 may instead be a pin or other object that is inserted to prevent removal of the neck 120 from the handle 130. Other locking mechanisms such as a twist-lock or push button lock can be used to prevent accidental removal of the neck 120 from the handle 130 of the flossing device 100. The inner chassis 570 surrounds sidewall spacer 663 to allow movement to the left and right, but not to the front and back. The sidewall space 663 is a disk protruding radially from the longitudinal axis of the elongated shaft 560. In other embodiments, the snap fitting 671 allows other attachments to be installed in place of the neck 120, such as a toothbrush head (not shown) or tongue scraper (not shown).

As seen in FIGS. 9B and 9C, the flat front/back sections 670 of the elongated shaft 560 prevent front-to-back movement of the elongated shaft 560 due to their interface with the inner chassis 570. These flat sections 670 interface with the inner chassis 570 with little to no freedom of movement and thus do not allow front-to-back movement of the head unit 110 and the floss 112. These flat sections 670 prevent front-to-back movement because the left-to-right movement is more comfortable and more effective for users when flossing.

FIG. 10 illustrates a front perspective view of the stem 800 of the elongated shaft 560 of the handle 130 of the flossing device 100. The stem 800 includes the sidewall space 663 and drive mechanism interface 664. The drive mechanism interface 664 includes an eccentric collar 751 which interfaces with the cam 667 with large gear 566 of FIGS. 8A-9C above. The eccentric collar 751 has a square or rectangular shaped opening 752 with interior rounded surface edges 753 that may be pushed by the cam 667. These rounded surface edges 753 also slightly rotate the elongated shaft 560 to provide the primarily left-to-right movement of the head unit 110. The eccentric collar 751 has one side 754 that is more rounded to reduce up-down movement.

FIGS. 11A-11C illustrate the flossing device 100 shown in FIGS. 1A-1G with a wall mount 442. Specifically, FIG. 11A illustrates a front perspective view of the flossing device 100 attached to the wall mount 442, FIG. 11B illustrates a side view of the handle 130 of the flossing device 100 as attached to the wall mount 442, and FIG. 11C illustrates a perspective view of the handle 130 of the flossing device 100 and the wall mount 442 in a separated state. The magnetic wall mount 442 is attracted to the metallic plate 444 shown in FIG. 5 above and in FIG. 11C. When mounted to a wall, the magnet within the wall mount 442 is strong enough to secure the flossing device 100. The metallic plate 444 is positioned within the handle in a centered location accounting for both the weight of the neck 120 and the head unit 110 as well so that the flossing device 100 is held in a balanced position. In some embodiments, the metallic plate 444 may include a small magnetic force to secure to the magnet within the wall mount 442, however the magnetic field generated by the drive motor 590 itself, may also be strong enough to secure the device 100 to the magnet within the wall mount 442.

The invention includes a vibrating flossing device and methods of using the device. The invention provides a replaceable or permanent flossing head unit that provides a vibrational aid that is activated when flossing.

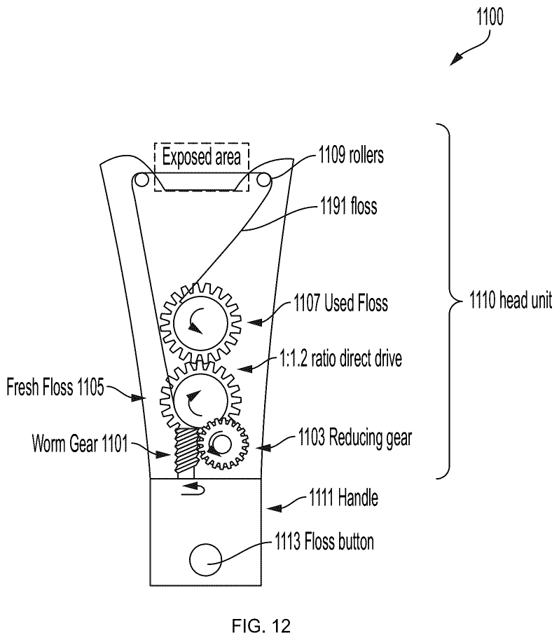

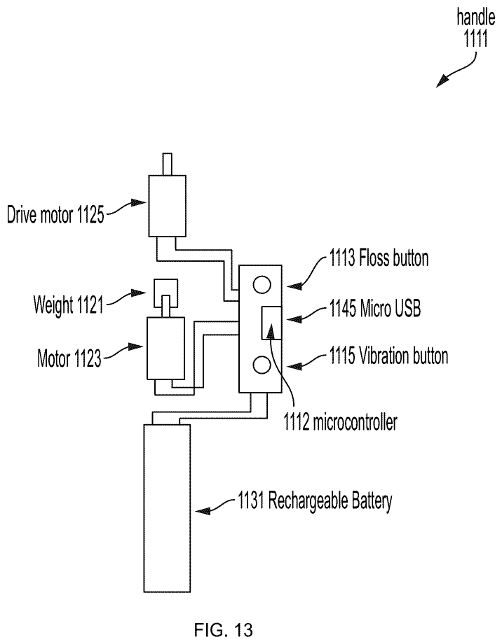

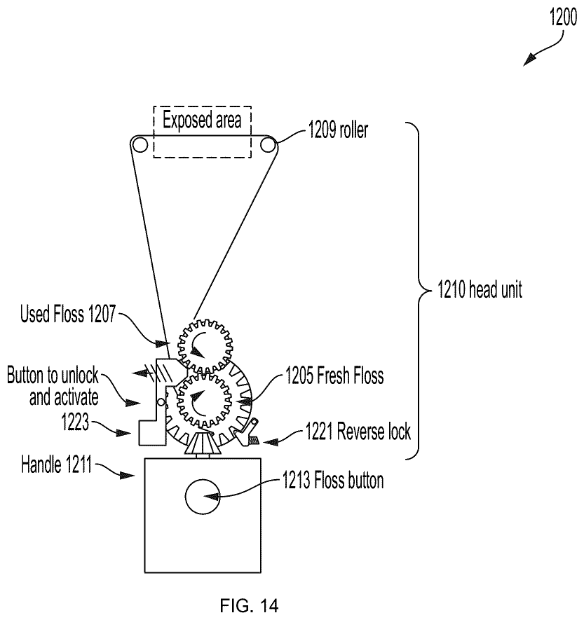

FIGS. 12 and 13 illustrate a first exemplary embodiment of a flossing device 1100 in accordance with the invention, wherein FIG. 12 shows interior components of the head unit 1110 and FIG. 13 shows interior components of the handle 1111 of FIG. 12. For ease of illustration, the handle 1111 in FIG. 1 is represented as a box, and the head unit 1110 is outlined in shadow. Although the dimensions of the handle 1111 are relative, the handle 1111 has a size and structure that is convenient and ergonomic for most people to hold in their hand. Similarly, the head unit 1110 is configured to conveniently fit into a user's mouth. Certain implementations of the invention can include multiple sizes, such as a “Big Mouth” version or a “Little Mouth” version. For ease of illustration, the outline of the head unit 1110 in FIGS. 14-17 is not shown.

In FIG. 12, the handle 1111 includes a floss actuator 1113 (e.g., a button or a switch) which is depressed by the user to advance floss 1191 and to initiate vibration. The floss actuator 1113 can have a single setting such that pressing the actuator 1113 will both advance floss via the drive motor 1125 and vibrate the vibration motor 1123. The floss actuator 1113 can alternatively have a number of detents to separately advance and vibrate the floss 1191. For example, a first detent can advance the floss 1191, and a further depression of the actuator 1113 to a second detent will additionally vibrate the floss 1191. Depending on the specific implementation of the invention, depressing the floss actuator 1113 can advance the floss 1191 by a given length, for example, about 1 inch (about 2.5 cm), or depressing the actuator 1113 can advance the floss 1191 continuously at a predefined rate.

In FIG. 12, the head unit 1110 includes a drive gear 1101 in the form of a worm gear, a floss supply gear 1105 connected to a supply spool of fresh floss (not illustrated), and a floss take-up gear 1107 for accommodating a take-up spool of used floss (not illustrated). The spools accommodating fresh and used floss 1191 can be distinct structures on the gears. As seen in FIG. 12, the floss supply gear 1105 and the floss take-up gear 1107 are turned by a drive gear 1101 in the head unit 1110 interfacing with the handle 1111 of the device 1100. A reducing gear 1103 connects the drive gear 1101 to the supply floss gear 1105 in order to reduce the rotational speed of the supply floss gear 1105 and thereby prevent floss 1191 from advancing too rapidly in the device 1100. Pins or similar structures can be located near the top of the device 1100 on opposite ends of the exposed length of the floss 1191 to guide the floss 1191 so that it moves in the desired direction in the device 1100.

In some exemplary embodiments, the gear teeth of the floss supply gear 1105 and the floss take-up gear 1107 are in a 1:1.2 ratio in order to maintain the floss 1191 in tension for flossing. The ratio of the floss supply gear 1105 and the floss take-up gear 1107 will often range from 1:1 to 1:10 but could be larger or smaller. The shaft of the drive gear 101 in the head unit 1110 fits into a predesigned cavity of the handle 1111 so that the drive motor in the handle 1111 can turn the drive gear 1101 as designed. The drive gear 1101 has the useful property of functioning as a lock to prevent floss 1191 from moving in a retrograde direction. The reducing gear 1103 cannot turn the drive gear 1101 because the angle on the drive gear 1101 is sufficiently shallow that friction between the reducing gear 1103 and the drive gear 1101 holds the drive gear 1101 in place. The use of a drive gear 1101 therefore does not require a separate locking device (see, e.g., FIGS. 14-17) to prevent the gears from being unintentionally advanced. In order to change the gear ratio of the components or the rate at which the gears turn, the drive gear 1101 can be exchanged with another drive gear 1101 having a different thread.

Although the drive gear 1101 (e.g., worm gear) in FIG. 12 is shown as part of the head unit 1110, in other embodiments the drive gear 1101 can be a part of the handle 1111. In such embodiments, the drive gear 1101 remains integral to the handle 1111 if the handle 1111 and head unit 1110 are disconnected, for example, if the head unit 1110 is to be replaced to provide a fresh supply of floss 1191. Advantageously, the invention maintains used and unused floss 1191 in different locations, on different spools (not shown), to reduce the chances of contamination from the used floss 1191. If the floss 1191 loses tension or becomes slack in the head unit 1110 any reason, the floss 1191 can be advanced to re-tension it.

FIG. 13 illustrates interconnections between components located in the interior of the handle 1111 of the flossing device 1100 shown in FIG. 12. The components of the handle 1111 shown in FIG. 13 include a microcontroller 1112, power supply 1131, drive motor 1125, and vibration motor 1123. The microcontroller 1112 is in the form of a printed circuit board having a floss actuator 1113, vibration actuator 1115, and a micro USB or other charging and/or communication interface 1145. The microcontroller 1112 can be programmed using an integrated development environment (IDE) developed by the microcontroller manufacturer and is typically programmed using a higher-level language such as C++ or Java. A non-limiting list of examples of manufacturers of microcontrollers include Texas Instruments, Arduino, MicrochipTechnology, Atmel, Intel, Sony, and Ubicon.

In certain embodiments, the microcontroller 1112 can be programmed to store usage data, such as length of use, amount of floss consumed, and frequency of use, and this information can be downloaded to a computer (not shown) such as a minicomputer, desktop, laptop, or smart phone via an application program or an app. The program or app can keep a record of the use of the flossing device 1100. In certain embodiments, the flossing device's 1100 programming can be updated via the micro USB or another charging and/or communication interface 1145, and usage data can be provided to a computer for diagnostic or motivational purposes.

The floss actuator 1113 on the handle 1111 works with the floss 1113 and vibration actuator(s) 1115 on the microcontroller 1112 to cause the drive motor 1125 to advance the floss 1191 and the vibration motor 1123 to vibrate the floss 1191. The charging and/or communication interface 1145 on the handle 1111 accommodates a micro USB cable to recharge the battery at a lower voltage than a domestic power line. Other types of connectors or charging interfaces can be used instead of a micro USB depending on the particular implementation of the invention. Instead of a power supply 1131 that is a rechargeable battery, one or more disposable batteries such as a conventional AA or AAA batteries can be used, or the flossing device 1100 can be plugged into a conventional wall socket to power the device 1100 during use.

The drive motor 1125 shown in the handle 1111 of FIG. 13 drives the drive gear 1101 in the head unit 1110 to advance the floss 1191 as desired, and can be, for example, a brushless cylinder motor. The ERM vibration motor 1123 in FIG. 13 causes the device 1100 and hence the floss 1191 to vibrate to thereby provide additional motion and cleaning while flossing. In other example embodiments, the motor is a counter-weighted 1121 vibration motor.

The vibration motor 1123 provides a vibration to the head unit 1110 which in turn vibrates the contained floss 1191 so that the floss is more effective at cleaning the teeth. The vibration motor 1123 can displace the head unit 1110, and subsequently the floss 1191, to allow the floss 1191 to penetrate tight spaces between the teeth more easily and also aid in more effective removal of plaque. The vibration motor 1123 rotates and in combination with other vibrational mechanisms can generate the movements. In one embodiment of the invention, the vibration motor 1123 is an eccentric rotating mass (ERM) vibration motor, sonic vibration motor, or linear resonance actuator (LRA) motor, which provides a vibratory effect to the exposed length of floss. Some ERM vibration motors can include a brushless cylinder motor. In another embodiment of the invention, the vibration motor 1123 can be a sonic vibration motor or LRA motor. The flossing devices 1100 in accordance with the invention can include a handle 1111 that can include a microcontroller 1112 to operate the vibration motor 1123, however, in some embodiments, the vibration motor 1123 does not require a microcontroller 1112 to operate. The flossing device 1100 utilizes waterproofing and/or water-resisting features so that water or liquid used to rinse or clean the device 1100 does not seep into the interior floss storage compartment(s) or the power circuitry in the head unit 1110 and/or handle 1111.

The vibration motor 1123 fits within the body of the handle 1111 and has a higher torque (for example, between 13 g-cm during max efficiency, and 30 g-cm at max power) to prevent binding by the vibration motor 1123 when the flossing device 1100 is in use. Binding commonly occurs when the head unit 1110 is flexed, bent, or when stress is placed upon the head unit 1110 while in use. The vibration motor 1123 can run between 6000 and 12000 revolutions per minute (RPM), however, vibration motor 1123 at 12000 RPM with higher torques of between 13 and 30 g-cm were preferable to prevent the motor from binding or stalling during use. Although, in this vibration motor 1123 these torques are preferred, in other embodiments where ERM, sonic vibration motors, LRA motors, or counter-weighted motors are used, other torque and RPM specifications can be used.

FIG. 14 shows another example embodiment of a flossing device 1200 according to the invention, in which floss supply gear 1205 and take-up gear 1207 in the head unit 1210 are turned by a drive gear 1201 in the form of a conical pinion gear. The drive gear 1201 turns the floss supply gear 1205 which has a supply spool (not shown) of fresh floss 1191, and this floss supply gear 1205 in turn turns a floss take-up gear 1207 which has a take-up spool (not shown) for used floss 1191. An actuator 1213 on the side of the device 1200 is used to unlock and activate the flossing device 1200 for use. A reverse lock 1221 is present on the floss supply gear 1205 to prevent the gear 1205 from moving in a retrograde direction which would thereby unspool the floss 1191 and remove the tension from the floss 1191. In this embodiment, the floss supply gear 1205 drives the floss take-up gear 1207 so that both rotate in synchronicity when the device 1200 is in use. The handle 1311 in FIG. 14 can have the same general structure as the handle 1211 in FIG. 13. The gears 1305 and 1307 can have a gear ratio which is not in unity so that the floss 1191 remains under tension during use.

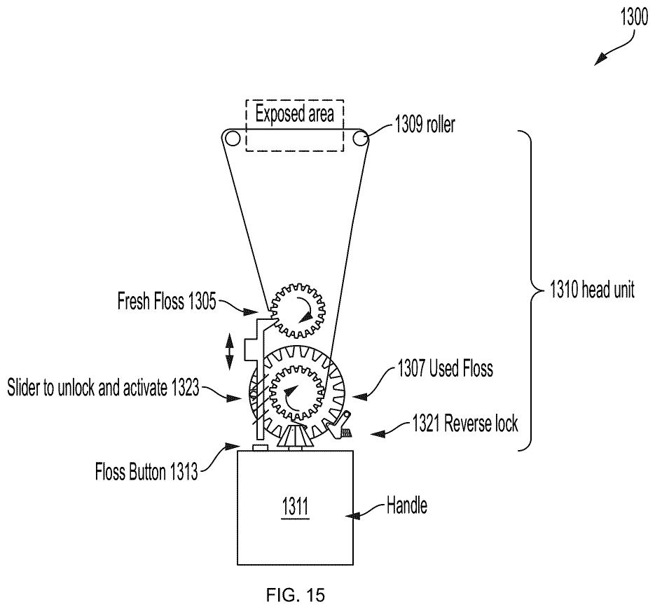

FIG. 15 shows another example embodiment of a flossing device 1300 according to the invention, in which a slider 1323 unlocks the floss supply gear 1305 and activates the device 1300. In this illustrated embodiment, the position of the floss actuator 1313 on the handle 1311 has been shifted from a side of the handle 1311 to the top of the handle 1311. The slider 1323 on the left side of the device 1311 moves down to unlock the supply floss gear 1305 and depresses the floss actuator 1313 to activate the flossing device 1300. The floss take-up spool (not shown) is part of the floss take-up gear 1307 which in turn is driven by the drive gear 1301 attached to the handle. In FIG. 15, the floss supply gear 1305 and the floss take-up gear 1307 are not both driven by the drive gear 1301 (a conical pinion gear in this embodiment) as they were in FIGS. 12 and 14, but rather the drive gear 1301 drives the floss take-up gear 1307 which creates a tension on the floss 1191. This tension causes the floss 1191 to advance within the device 1300 so that the user can have fresh floss.

To deactivate the flossing device 1300 and lock the floss supply reel (not shown), the slider 1323 is moved upwards. In this configuration, the floss actuator 1313 is no longer depressed and floss 1191 would no longer be advanced and vibration will stop. A reverse lock 1321 is used in this embodiment in order to prevent the floss 1191 from moving in a reverse direction.

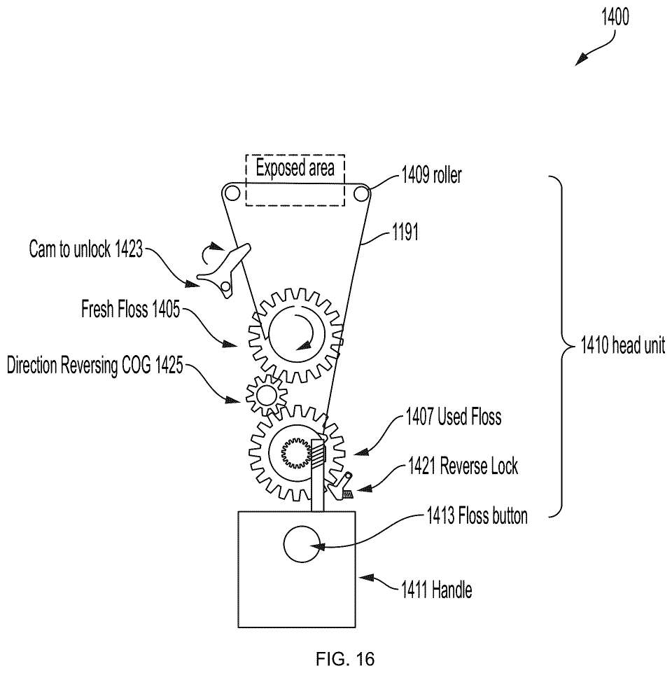

FIG. 16 shows another example embodiment of a flossing device 1400 according to the invention. In FIG. 16, a drive gear 1401 that is a cylindrical pinion gear serves to drive the floss take-up gear 1407. The floss supply gear 1405 is driven by the floss take-up gear 1407 via an intermediate direction-reversing cog 1423. To prevent unintended advancement of floss in the device, a cam 1427 and a reverse lock 1421 are used. To maintain the floss 1191 under tension during use, the supply gear 1405 and take-up gear 1407 can have slightly different numbers of gear teeth so that the ratio of the two gears is not in unity.

In FIG. 16, the handle 1411 has a single floss actuator 1413 for advancing floss 1191 and engaging the vibration motor (shown in FIG. 13, 1123) although, consistent with the invention, there can be separate actuators (not shown), sliders (not shown), or other kinds of switches (not shown) for the drive motor 1125 and the vibration motor 1123. As in the previous embodiments, the head unit 1410 is detachable from the handle 1411 via a locking mechanism (not shown).

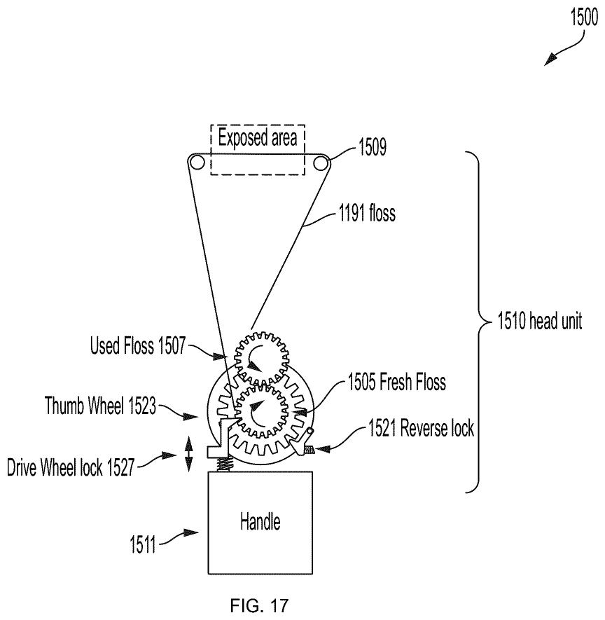

FIG. 17 illustrates a fifth embodiment of a flossing device 1500 according to the invention, in which the floss 1191 is advanced manually via a drive wheel 1523 using a user's thumb or other finger. In this embodiment, the handle 1511 does not accommodate a drive gear, although a vibration motor (shown in FIG. 13, 1123) can still be present to provide a vibratory effect during use. The gearing arrangement in the head unit 1510 is similar to the gearing arrangement in FIG. 14, although in FIG. 17, the drive wheel 1523 can slide down to turn on a vibration motor (shown in FIG. 13, 1123) via an actuator on the top of the handle (as shown in FIG. 15). The floss supply gear 1505 and take-up gear 1507 have a gear ratio slightly different from unity in order to maintain tension on the floss 1191 during use. A drive wheel lock 1527 is located on the left side of the head unit 1510 to lock and unlock the supply/drive gear 1505 which prevents the inadvertent advancement of floss 1191. A reverse lock 1521 is used on the supply/drive gear 1505 to prevent the gear 1505 from moving in a retrograde direction and thereby reducing tension on the floss 1191 or contaminating the clean floss.

In FIG. 17, the floss 1191 is advanced by turning the drive wheel 1523 which can extend outside the housing of the head unit 1510. The embodiment of FIG. 17 minimizes the presence of electronic components in the device when this is deemed desirable.

FIGS. 18A-18F show top (FIG. 18A), bottom (FIG. 18B), left side (FIG. 18C), front (FIG. 18D), right side (FIG. 18E), and rear (FIG. 18F) views of an exemplary embodiment of a flossing device according to the invention. The illustrated flossing device 1700 includes a head unit 1710 and a handle 1711 which are joined by a locking mechanism (not shown). The head unit 1710 includes a drive gear (see FIGS. 12-17), floss supply gear (see FIGS. 12-17), and floss take-up gear (see FIGS. 12-17). The head unit 1710 is in the shape of a semi-circle with distal arms 1743 extending from the portion of the head unit 1710 that is connected to the handle 1711. The head unit 1710 includes an exposed length of clean floss 1191 for use. The head unit 1710 can also include a cover (not illustrated) which covers a portion of the head unit 1710, that holds the exposed floss 1191, when not in use to prevent contamination of the floss 1191. The illustrated embodiment has a distal arms 1743 separated by a width w of about 1 inch (2.5 cm) and an overall length of about 7 inches (about 18 cm).

In some embodiments, the housing of the head unit 1110 includes a pair of arms that can be moveable from a closed configuration wherein the distal ends of the arms enclose the path of floss to prevent contamination of previously unused floss, to an operational configuration wherein the distal ends of the arms separate to open the exposed length of floss for use. In some embodiments, the arms are in a fixed configuration to hold the floss in place. The housing of the head unit 1110 can further include a cover which is removed by detaching, sliding, or otherwise moving the cover to expose floss for use. After flossing is complete, the cover can be reaffixed to the head unit so that the floss remains clean and sanitary for subsequent use.

The handle 1711 of the exemplary flossing device 1700 shown in FIGS. 18A-18F includes an actuator 1713 that is a button or switch for initiating operation, powering on/off the flossing device 1700, setting a vibrational strength, feeding the floss 1191, and/or other functionality. The actuator 1713 can be configured with several detents so that pressing the actuator 1713 once will advance floss, while a further detent will vibrate the floss. Alternatively, the actuator 1713 can be configured so that pressing the actuator 1713 once will initiate vibration while a further detent advances the floss, or pressing the actuator 1713 continuously to maintain vibration while a further detent will advance floss. There can be a continuum of vibrational limits so that the more times the user presses the actuator 1713, the stronger or weaker the vibration of the floss 1191. It is to be clear that such vibrational and “floss advancing” configurations using an actuator 1713, a plurality of actuators, or alternative mechanisms are within the scope of the invention.

The handle 1711 has a cylindrical shape that can house the components in a form factor that allows a user to grasp the main cylinder 1712 (as shown in FIG. 18F) of the handle 1711. In some embodiments the handle 1711 is made of aluminum. In other embodiments, the handle 1711 is made of other non-liquid permeable materials to hold the components of the flossing device 1700, such as a carbon fiber or other plastics. In other embodiments, the handle 1711 includes a grip for a user to better grasp the flossing device 1700.

In FIGS. 18A-18F, the exemplified flossing device has a set of seven indicators 1735 that are LEDs which can be configured to show various functions. These indicators 1735 can indicate the amount of power left in the power supply (reference numeral 1131 shown in FIG. 13, for example), amount of floss left in the clean floss supply spool, amount of vibration, or for tracking daily usage such as one LED for each day of the week. For example, Monday can be green, Tuesday can be pink, Wednesday can be blue, etc. These indications can also be selected or created by a user from the device or through an application the device can connect with.

The flossing device 1700 can include a charging and/or communication interface 1745 that includes a conventional micro-USB, USB-C, or other charging interface 1745 to facilitate charging. A compatible micro-USB, USB-C, or other charging interface cable can be included in an optional kit provided to customers by the manufacturer or users can obtain charging cables from a retailer. The use of an industry-standard charging interface such as a micro-USB or USB-C allows customers to readily use their own charging cables or to connect their flossing devices to a computer or smartphone for device updates or to obtain a record of the device's use, such as daily flossing time. In other embodiments of the invention, an alternative charging interface such as a USB interface, a proprietary interface, or other interfaces can be used.

The configuration of the head unit 1710 having a semi-circular shape allows a user to conveniently insert the flossing device 1700 in his or her mouth and maneuver the floss in between and around teeth. The configuration or appearance of the head unit 1710, or the flossing device 1700 in general, will depend upon the particular implementation of the invention. For example, smaller arms 1743 can be used for children. The head unit 1710 also can be replaced or include a cleaning tool (not illustrated) such as a scraper to prevent food debris, plaque, or excess moisture removed by the floss 1191 from entering the head unit 1710 in order to minimize unhygienic conditions inside the flossing device 1700. Additionally, the user can use water, whether forced on the floss or for placement in, to remove debris/plaque from the floss during and after use.

Most of the non-electrical components of the device 1700 include plastic/injection molded components. These components can be made from plastics including acrylonitrile butadiene styrene (ABS), polypropylene (PP), or other bioplastic such as polylactic acid (PLA) or poly lactide, polybutylene terephthalate (PBT), closed cavity bag molding (CCBM) which includes a mix of PLA and PBT that are biodegradable and compostable, or other biodegradable and compostable plastic with enough strength to provide the structure for the device 1700.

In some embodiments, the exterior housing of the handle 1811 can be made of aluminum to prevent corrosion and to provide a lighter weight, yet strong material. In some embodiments, the handle 1811 can be made of other materials that are non-corrosive, strong, prevent liquid ingress, and lightweight, such as carbon fiber or plastics.

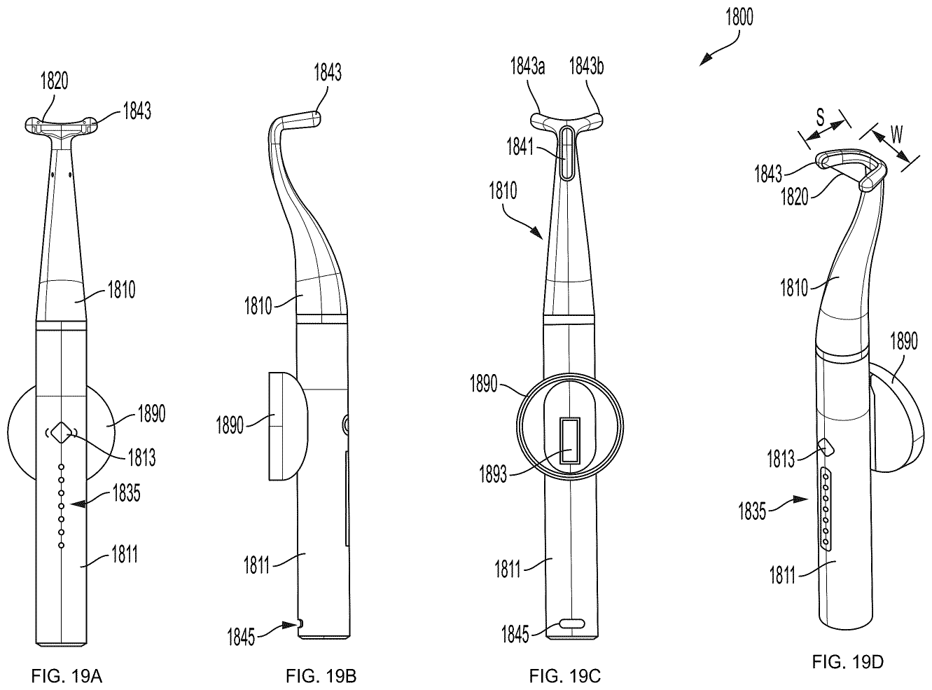

FIGS. 19A-19D show front (FIG. 19A), left side (FIG. 19B), back (FIG. 19C), and right side (FIG. 19D) views of a flossing device 1800 with a wall mount 1890. The flossing device 1800 including a head unit 1810, and handle 1811. The head unit 1810 includes rounded surfaces and a semi-circular wishbone shape with distal arms (1843a and 1843b) extending from handle 1811. The rounded surfaces prevent irritation and injury to the user's mouth. The arms 1843a and 1843b provide enough space to allow the floss 1820 running between the arms 1843a and 1843b to enter tight spaces between teeth without running into the teeth by providing depth n. Further, the width w between the arms 1843a and 1843b limit irritation to a user's cheek and tongue surfaces.

The head unit 1810 includes a bite pad 1841. The bite pad 1841 can be made of any number of materials including silicone or rubber to allow a user of the flossing device 1800 to aid flossing by biting down on the bite pad 1841 with the opposing teeth or gums. The bite pad 1841 provides the user with greater control of the floss 1820, allowing them to comfortably penetrate the floss 1820 between tightly spaced teeth, and offering much greater control in doing so relative to manual flossing. For example, when flossing the bottom set of teeth, a user can bite down on the back of the head unit 1810, generally on the bite pad 1841, and push the floss 1820 further in between the gums and/or teeth. The bite pad 1841 is approximately 2 mm thick. The bite pad 1841 can be attached to the head unit 1810 through adhesives or a fastener.

The handle 1811 includes actuator 1813 and indicators 1835. The handle 1811 also includes an attachment mechanism to attach to wall mount 1890. In one embodiment, the wall mount 1890 includes a magnet 1893 that is attracted to a metal plate (not shown) or magnets (not shown, including potentially, the drive or vibration motors 1125 and 1123) of the handle 1811. The metal plate (not shown) can be located in a centered location of the device 1800 to account for the weight of the head unit 1810 to hold the device 1800 in a balanced position. The magnetic forces of the attachment mechanism are strong enough to hold the device 1800 to the wall. In some embodiments, the attachment mechanism physically encapsulates the entire handle 1811.

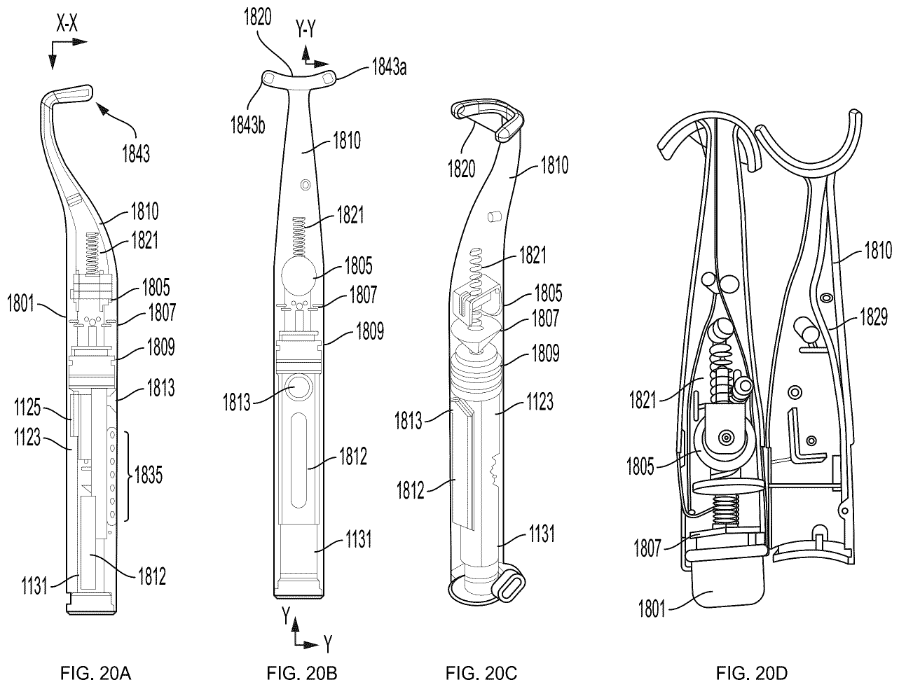

FIGS. 20A-20D show various interior views of a flossing device 1800 in accordance with an embodiment of the invention. FIG. 20A shows a left side view, FIG. 20B shows a front view, and FIG. 20C shows a front-right perspective view of the flossing device 1800 with a clear external housing (not labelled). As shown in FIGS. 20A-20C, the handle 1811 includes a power source 1131, vibration motor 1123, drive motor 1125, and a microcontroller 1812 with actuator 1813 and indicators 1835. The floss take-up gear 1807 is driven by drive motor 1125 (shown in FIGS. 20A-20C). In this embodiment, the floss take-up gear 1807 is driven directly by the drive motor 1125, and thus, the drive motor 1125 is located more proximate to the head unit 1810 than the vibration motor 1123, however, in some embodiments, the drive motor 1125 can indirectly drive the floss take-up gear 1807 and can be placed further from the head unit 1810 than the vibration motor 1123 (thus potentially allowing a stronger vibrational force).

FIG. 20D shows an opened head unit 1810, split in half, of the flossing devices 1800 of FIGS. 20A-20C. The interior of the head unit 1810 is shown with male connection section 1801, floss supply gear 1805, floss take-up gear 1807, reverse lock 1821 and housing floss guides 1829. The floss take-up gear 1807 pulls used floss from the floss supply gear 1805 through the head unit 1810. This pulling also momentarily compresses the reverse lock 1821 to “unlock” and allows the floss supply gear 1805 to rotate. The drive motor 1125 rotates to allow approximately one inch of fresh “new” floss to rotate through the head unit 1810 and collect the old “used” floss in a spool of the floss take-up gear 1807. The reverse lock 1821 spring, once the drive motor 1125 stops rotating, decompresses and re-locks the floss supply gear 1805 to prevent the floss 1820 from moving and keep the floss 1820 taught during use of the flossing device 1800. The reverse lock 1821 blocks movement of the floss supply gear 1805 by tightly inserting between teeth of the floss supply gear 1805 from the force of the spring of the reverse lock 1821. When released, by compressing the spring of reverse lock 1821, the floss supply gear 1805 turns without as much interference (e.g., turns with some friction or stopping force such as notching) or freely. In some embodiments, the reverse lock 1821 is actuated using the actuator 1813 or microcontroller 1812, however, the reverse lock 1821 prevents accidental feeding of new floss 1820 and keeps the floss 1820 in the device 1800 taught for flossing by a user.

The housing floss guides 1829 are channels in the housing of the head unit 1810 that guide the floss 1820 through the head unit 1810 from the floss supply gear 1805 to the floss take-up gear 1807. The floss supply gear 1805 includes or is attached to a spool of floss 1820 that includes approximately 100 inches or a 90-day supply of floss for a user. The head unit 1810 is an air-tight compartment for keeping the floss 1820 in a sterile condition.

In some embodiments, as described above, the head unit 1810 can include a sanitizer reservoir (not shown) that applies sanitizer to used floss to help eliminate bacteria on the floss as well as to prevent bacterial growth. The sanitizer can be a liquid or a gel, for example, and can include one or more disinfectant, antiseptic, bactericidal and/or bacteriostatic agents. In one example, alcohol and/or quaternary ammonium compounds are used. The sanitizer reservoir can be in the head unit and apply sanitizer to the used floss at any appropriate position in the device, such as when on the head unit. In other embodiments, the sanitizer reservoir can extend from the handle or neck to the head unit to apply sanitizer on the floss. The sanitizer can be applied to the used floss by any convenient method, such as by running the floss against a sponge moistened with the sanitizer. In other embodiments, the sanitizer can be in the form of an ultraviolet lamp which shines ultraviolet light on the device to eliminate bacteria. The ultraviolet lamp can be a UV-C diode that disinfects the floss by killing bacteria.

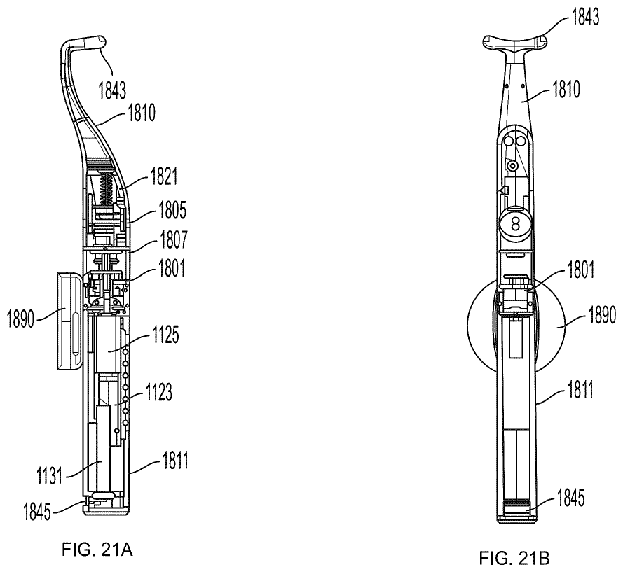

FIGS. 21A and 21B show various cut-away views of a flossing device 1800 in accordance with an embodiment of the invention. FIG. 21A is a cut-away view along the y-y plane of the flossing device 1800 shown in FIG. 20B, and FIG. 21B is a cut-away view along the x-x plane of the flossing device 1800 shown in FIG. 20A. FIGS. 21A and 21B show the same components as FIGS. 20A-20D in further detail.

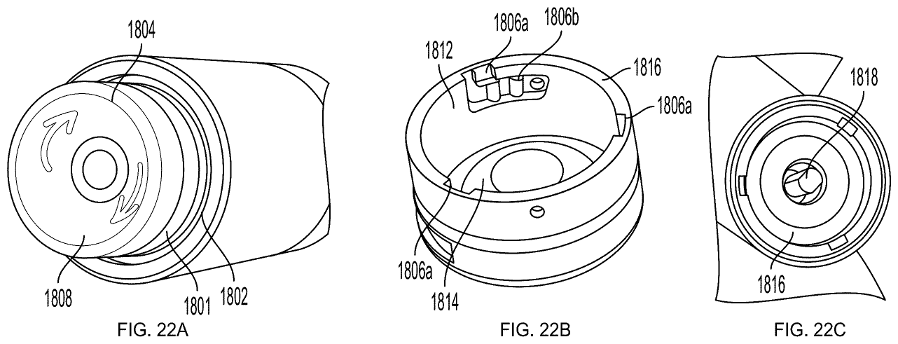

FIGS. 22A-22C show a connection between a handle 1811 and head unit 1810 of the flossing device in accordance with an embodiment of the invention. The head unit 1810 is secured to the handle 1811 with a male connection section 1801 that corresponds to a female connection section 1816 of the handle 1811 with a twist-lock mechanism (1804 and 1806A). Additionally, the male and female connection sections (1801 and 1816 respectively) include a drive motor 1125 connection shaft 1818 (see FIG. 22C), to feed the floss 1820 through the head unit 1810. The head unit 1810 male connection section 1801 mates with female connection section 1801 of the handle 1811.

The male connection section 1801 includes a protruding section 1802 with three tabs 1804 that are placed in cavity 1812 that corresponds to the shaped of the protruding section 1802 at slots 1806A. The slots 1806A include grooves 1806B that allow the tabs 1804 to be twisted and secured into the slots 1806A to prevent accidental separation of the head unit 1810 and handle 1811. The slots 1806A include a right angle turn and include the grooves 1806B in that lock-in the tabs 1804. The grooves 1806B include two blocking ridges that prevent a tab 1804 from sliding out of the slot 1806A without a predetermined removal force (i.e., twisting force) to separate the head unit 1810 from the handle 1811. The protruding section 1802 also includes a concave portion 1808 that mates with a convex portion 1814 of the cavity 1812 to help align the head unit 1810 and handle 1811 when being secured. The cavity 1812 includes a D-shaped shaft 1818 that mates with the male connection section 1801 to drive the mechanisms connected to the spool of floss 1820 and prevents improper placement as well as provides a surface to rotate the spool of floss 1820 connected to the male connection section 1801. In some embodiments, the male connection section 1801 is a part of, or is also, the drive gear of the device 1800.

In some embodiments, the male connection section 1801 and female connection section 1816 are reversed (i.e., male connection section 1801 is part of handle 1811 and female connection section 1816 is part of the head unit 1810. In some embodiments, the twist-lock mechanism can instead be other locking mechanisms such as a pin, snap fitting, push-button, or other lock that prevents accidental removal of the head unit 1810 from the handle 1811. The locking mechanisms 1801 and 1816 are capable of withstanding the forces of removal and replacement of many head units 1810 for flossing when replacing and removing head units 1810 to provide sanitary floss 1820 for the flossing after/before uses. Further, the locking tabs 1804 prevent removal/dislodging of the head unit 1810 during normal use (i.e., flossing). In some embodiments, the male connection section 1801 includes more or less than three locking tabs 1804, as long as the locking mechanism prevents accidental removal of the head unit 1810 from the handle 1811 during normal use.

The head unit 1810 has a semi-circular wishbone shape that allows the head unit 1810 of the flossing device 1800 to reach the back of a user's mouth without irritation. In other embodiments, the shape of the head unit 1810 can have a different cross-sectional shape (e.g., rounded rectangle) and/or can be straight rather than S-shaped as long as the head unit 1810 of the flossing device 1800 can reach the back of the user's mouth with ease and without irritation. By using the device 1800, user's hands/fingers, which are often unsanitary portions of the body, are not used.

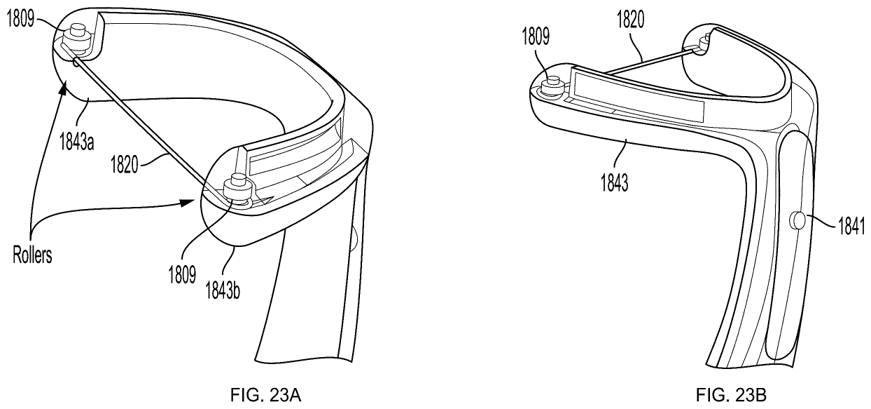

FIGS. 23A and 23B illustrate various views of distal ends that hold floss 1820 of a head unit 1810 of a flossing device 1800 in accordance with an embodiment of the invention. FIG. 23A shows a front-right perspective and FIG. 23B shows a back-right perspective view of the arms 1843 of the head unit 1810. The distal portions of the arms 1843 include rollers 1809 that guide the floss 1820 into the unprotected section between the arms 1843. The rollers 1809 prevent floss 1820 from breaking due to sharper edges along the housing of the head unit 1810. The rollers 1809 further provide tension to the floss 1820 so that when used, the floss 1820 stays taught and can remove plaque and other objects from between teeth and gums. FIG. 23B also shows the location of the bite pad 1841 and its proximity to the floss 1820.

Variations and modifications will occur to those of skill in the art after reviewing this disclosure. The disclosed features may be implemented, in any combination and sub-combination, with one or more other features described herein without limitation. The various features described or illustrated above, including any components thereof, may be combined or integrated in this or other systems. Moreover, certain features may be omitted or not implemented.

Examples of changes, substitutions, and alterations are ascertainable by one skilled in the art and could be made without departing from the scope of the invention disclosed herein. All references cited herein are incorporated by reference in their entirety and made part of this application.

The claimed invention is:

1. A flossing device that provides a horizontal vibrational movement for flossing, the device comprising:
a head unit that interfaces with a neck;
the neck communicatively coupled to the head unit at a proximal end and coupled at a distal end to a handle; and
the handle, wherein the handle comprises:
a drive motor,
a drive mechanism that transfers drive motor rotation into a horizontal displacement of the head unit to generate the horizontal vibrational movement while flossing.

2. The flossing device of claim 1 further comprising:
a power unit.

3. The flossing device of claim 2, wherein the handle comprises an interface to a power cable for charging the power unit.

4. The flossing device of claim 1, wherein the head unit includes floss.

5. The flossing device of claim 1, wherein the drive mechanism includes a pinion gear fitted in a cavity in the handle and powered by the drive motor.

6. The flossing device of claim 1, wherein the neck or the head unit includes a bite pad as a location for a user to bite down to manipulate floss during flossing.

7. The flossing device of claim 1, further comprising:
a wireless transceiver to communicate with another device.

8. The flossing device of claim 1, wherein the drive mechanism includes a cam and an eccentric collar that generates horizontal left-right displacement as the cam rotates.

9. The flossing device of claim 1, wherein the drive mechanism includes:
an elongated shaft with a head adapter to secure the neck;
a sidewall spacer surrounding a portion of the elongated shaft and to limit the portion of the elongated shaft to the horizontal left-right displacement; and
an eccentric collar that mates with the drive motor to generate the horizontal vibrational movement of the head unit.

10. The flossing device of claim 9, wherein the sidewall spacer extends radially from a longitudinal axis of the elongated shaft.

11. The flossing device of claim 9, wherein the eccentric collar includes a substantially box-like shape.

12. The flossing device of claim 1, wherein the drive mechanism includes:
a pinion gear connected to a large gear, wherein the pinion gear is tapered and beveled to mate to the large gear and to transfer rotational force of the drive motor to the large gear and through to a cam and eccentric collar and wherein the cam rotates along an axis orthogonal to an axis of rotation of the pinion gear.

13. The flossing device of claim 1 further comprising:
an actuation switch to initiate horizontal vibrational movement of a length of floss.

14. The flossing device of claim 1, wherein the device is water-resistant.

15. The flossing device of claim 1, wherein the head unit includes a pair of spaced-apart arms extending to a distal end to hold a length of floss between the pair of arms.

16. The flossing device of claim 1, wherein the head unit includes a cover that is removed to expose floss for use.

17. The flossing device of claim 1, wherein the head unit is detachable from the handle and replaceable with another head unit.

18. The flossing device of claim 1, wherein the handle includes a single switch to initiate vibration of floss during flossing.

19. The flossing device of claim 1, further comprising:
a microcontroller in the handle to operate the drive motor.

20. The flossing device of claim 1 further comprising:
an indicator cue to indicate one or more conditions selected from the group of a time to change the floss, a low power level, and an incomplete connection between the head unit and the handle.
